(19) United States
(12) Patent Application Publication
(10) Pub. No.: US 2024/0277560 A1
(43) Pub. Date: Aug. 22, 2024

(54) Device and Method for the Treatment of Erectile Dysfunction and Peyronie's Disease

(71) Applicant: Nadi S. Hibri, San Antonio, TX (US)

(72) Inventor: Nadi S. Hibri, San Antonio, TX (US)

(21) Appl. No.: 18/170,174

(22) Filed: Feb. 16, 2023

(51) Int. Cl. A61H 19/00; A61H 9/00

(52) U.S. Cl. CPC A61H 19/32; A61H 9/0007; A61H 9/0057; A61H 9/0092; A61H 2201/169; A61H 2201/5056

(57) ABSTRACT

An external device for the treatment of erectile dysfunction and Peyronie's disease comprises a vacuum cylinder containing a dual sheath assembly having an outer tightening compartment and an inner vacuum compartment. A plurality of expandable chambers contained within the tightening compartment are inwardly radially expandable towards the user's erect penis within the vacuum compartment by selectively supplying fluid to the tightening compartment and to the expandable chambers under variable pressure. For example, this specification describes devices, systems, and methods for inducing an erection of a user's flaccid penis in a vacuum compartment of the invention and applying longitudinal and lateral traction forces by the dual sheath assembly and the expandable chambers therein to the erect penis to execute a treatment protocol specific to a patient suffering from erectile dysfunction and/or Peyronie's disease.

### BACKGROUND

This is a utility patent application claiming priority to utility patent application, U.S. patent application Ser. No. 17/174,050 filed Feb. 11, 2021, which is incorporated herein by reference.

### 1. FIELD OF THE INVENTION

The present invention relates generally to non-invasive penile erection aids and more specifically to vacuum pump therapy devices to induce and maintain erection while applying circumferential and longitudinal forces to a patient's penis to treat curvature and other ailments related to Peyronie's disease.

### 2. DESCRIPTION OF THE RELATED ART

About one-third of all grown-up men in the civilized world are more or less affected by erectile dysfunction ED, especially those of middle or older age, but also more and more younger men who are exposed to or susceptible to stress.

Peyronie's disease PD is a debilitating syndrome consisting of penile curvature, shortening of the penis, pain, and erectile dysfunction.

PD is an abnormality of the erect penis such as bend, curve, or hourglass shape narrowing which can negatively affect sexual function. Often PD can cause erectile dysfunction, emotional distress, depression, and relationship difficulties. It develops in up to 5-10% of men. PD occurs because of inflammation and scarring of the tunica albuginea, the inner lining of the penis that allows the penis to become hard during erection. This scarring is referred to as Peyronie's plaque. The true incidence is likely higher due to under-reporting from men not seeking treatment. [0006] Peyronie's disease is an acquired disease of the tunica albuginea manifested as aberrant wound healing. Although PD was first described more than 250 years ago, much of our understanding of this condition was realized over the past 25 years.

Concurrent ED and PD is common, and occurs in up to one-third or more of patients with chronic PD. PD is divided into an active phase and a chronic phase. The active or acute phase, which can last up to 18 months, is characterized by active plaque formation, penile pain with or without erections, and progressive penile deformity and length loss. The chronic phase, which has been defined as symptom stability and lack of progression for up to 3 months, is characterized by deformity stabilization, and pain improvement or resolution in most cases. Also, the palpable penile plaque, if present, may harden and flatten out. Commonly the plaque is located in the mid dorsal shaft or distally retro-coronal, and is anchored to the tunica albuginea. PD patients can have dorsal, dorsolateral, or ventral penile deformity.

In recent years, penile-traction therapy (PTT), with or without intralesional therapy, has gained considerable interest as novel non-surgical treatment options for men with PD and acquired short or small penises. The current published literature suggests that selected cases of PD may benefit from a conservative approach with PTT, resulting in increased length and reduction of penile deformity. The therapy appears to be safe and well tolerated but requires a great deal of patient compliance and perseverance.

The use of penile traction therapy PTT in the management of PD relies on the application of longitudinal and/or contralateral traction forces to the flaccid penis in an attempt to treat anatomical aberrations related to Peyronie's disease. Such devices, in general, are not structured to provide erectogenic treatment for those patients that suffer from concurrent erectile dysfunction.

Prior devices and methods utilized tensioning assemblies coupled to a frame and with a user's penis such that a longitudinal traction force and a lateral traction force can be applied to the penis. Portions of the assembly include splints and clamps configured to secure the penis and allow for subsequent release. Such prior devices are not geared to induce and maintain penile erection during the treatment session.

The role of vacuum pump therapy to mechanically straighten the penis in 41 patients enrolled into a study by Abdel Raheem et. al. over a twelve-week period, for 10 min. twice daily. Analysis of the published results showed there was a statistically significant improvement in the angle of curvature after twelve weeks of using the vacuum pump. The improvement in penile length was an encouraging feature. However, erectile and sexual function did not significantly change.

### SUMMARY OF THE INVENTION

In a broad aspect, the present invention is a vacuum erection control system for the treatment of ED and PD. The vacuum erection control system includes 1. A modified vacuum evacuation cylinder, and a dual sheath assembly including a vacuum compartment and a tightening compartment; 2. A plurality of individually controllable fluid pressurizable chambers stationed within the tightening compartment, and 3. A control supply unit for controlling and monitoring the tightening compartment and the pressurizable chambers. The vacuum compartment has a distal end for operable connection to a vacuum generating device, an open proximal end for receiving the patient's flaccid penis, an inside surface and an outside surface. An elastic tubular sleeve, disposed circumferentially, separates the vacuum compartment from the tightening compartment. During operation, the user's penis is introduced through the vacuum compartment and a vacuum is produced by the vacuum generating device operably connectable to the vacuum compartment. As an erection is enhanced and the penis advances towards the distal end of the vacuum compartment, the pressurizable chambers are controllably inflated and selectively pressurized to initiate rehabilitation and treatment of ED, increase penile length and girth, and straighten the abnormal curvature of a penis afflicted by PD.

In one embodiment, a concentrically disposed dual sheath assembly arrayed within the vacuum cylinder creating an outer annular space and an inner tubular space. A pressurizable pressure assembly may be positioned within the annular space to create a tightening compartment and the inner tubular space connected to a vacuum generating device distally to create a vacuum compartment receptive to a user's penis.

In one application of the dual sheath assembly, an outer elastic sheath member and an inner elastic sheath member may be formed of two compliant tubular membranes that may be bonded at their proximal and distal ends to enclose the tightening compartment. The outer elastic sheath may about the inner surface of the vacuum cylinder, and the inner elastic tubular member border the vacuum compartment. The inner elastic tubular member is radially stretchable between the tightening compartment and the vacuum compartment. The inner elastic tubular member is radially inwardly expandable by supplying fluid to the compartment under moderate pressure. The elastic sheath may be formed of a highly elastic material, preferably silicone. Thus, when inwardly expanded, the sheath is moved into a conforming contact with an erect penis within the vacuum compartment. The inner elastic sheath member provides a continuous smooth interior surface wrapped against the user's penis, thus providing a comfortable yet tight fit that can optimize a continuous vacuum seal along the entire penile shaft. The conforming contact sealingly engages the wall of the vacuum lumen to the user's penis to thereby produce an airtight seal throughout a procedure. Further, the conforming contact protects penile tissue and ensures user's comfort.

In a yet further application, the tightening compartment is bordered by an outer elastic tubular member extending along the inner surface of the rigid vacuum cylinder, which limits its outward expansion. The tightening compartment may be operably connected to a fluid pressure (gas or liquid) generating device. When the tightening chamber is thus pressurized or depressurized, the inner elastic tubular member may be biased inwardly towards the vacuum compartment to compress the erect penis therein, or relieve compression of the penis as needed.

In one embodiment, a flexible multi-lumen catheter and a plurality of pressurizable eccentric balloons mounted to the catheter are contained within the tightening compartment. The balloons are selectively and controllably expandable and contractible by providing a fluid separately to each balloon under a higher pressure (compared to the moderate pressure within the tightening compartment outside the balloons, and contained by the sheath members). In one embodiment, an actuator segment may be formed from a plurality of inflatable balloons arrayed at the distal end of a catheter. The balloons may be disposed within a catheter housing such that when the balloons are inflated, the balloons expand and extend eccentrically through windows formed in the housing. When deflated or mostly deflated, the balloons retract into the cavities formed in the catheter housing. When the catheter housing is rotated along its longitudinal axis, such that the windows face the vacuum compartment, the balloons generally expand eccentrically inward toward the central longitudinal axis of the vacuum compartment. The balloons are axially adjacent, and preferably immediately adjacent each other, with balloon-free gaps interposed therebetween.

In one application of the dual sheath assembly each balloon may be positioned within a cavity near the distal end of the catheter. Each balloon is eccentrically restrained within the cavity and, when inflated, is biased to project from the cavity window to urge the inner sheath member towards the vacuum compartment.

In one embodiment, an inflatable cuff includes a plurality of inflatable annular chambers fitted within the tightening compartment. The chambers are configured to expand and contract in linear sequence in order to rehabilitate and rejuvenate the penis of a patient suffering from ED.

In one embodiment, an inflatable cuff interposed between the tightening compartment and the vacuum compartment is provided with a plurality of expandable chambers arranged in an eccentric fashion within the inner elastic layer of the dual sheath assembly. The chambers are inflated selectively for applying contralateral penile traction and bending forces to the erect penis within the vacuum compartment to treat Peyronie's disease.

In one embodiment, a fluid source capable of sequentially contracting under pressure. The fluid source and the pressurizable balloons are in fluid communication through a conduit which enables fluid to flow from the fluid source to the balloons at a predetermined gradual rate when the fluid source is contracting, whereby the balloon expands gradually and controllably within the tightening compartment to effect deviation of the inner elastic sheath towards the organ within the vacuum compartment with sufficient impacting force to cause bending or deviation to a desired configuration and diameter.

In another implementation, a method of applying concurrent longitudinal, lateral deflection and pulsating forces to a patient's penis according to a physician's specifications.

The device further comprises a control/supply unit for sequentially pressurizing the eccentric balloons, maintain the pressure in each balloon for a predetermined period and thereafter exhausting the fluid pressure from the balloons. The fluid distributor performs this pressurization of the balloons within the tightening compartment of the dual sheath member in a controlled and programmable sequence to thereby augment vascular flow, within the erect penis, function as a circulatory aide, and provide stretching and/or bending in an appropriate manner as needed.

In some embodiments, the devices described herein are configured to exert concurrent vacuum and fluid pressure forces that are readily adjustable and quantifiable. In addition, Penile morphometries may be assessed in-situ and definite treatment plans may be ordered and implemented, and anatomical and functional improvements may be tracked over time. A wearable monitor may be conveniently mounted onto the patient's wrist, for example, that is capable of transmitting useful parameters through wireless communication so that the response to therapy can be efficiently managed. Hence, individualized treatment plans can be ordered and implemented, thereby potentially enhancing patient's satisfaction and motivation, and the response to therapy.

Preferably, the device is modular and may be assembled in different configurations and lengths, depending on the patient's needs. The patient should be able to disassemble the device for cleaning and maintenance, and reassemble the device without difficulty. The distal portion may be connected to a manually operated pump or an electric pump according to a user's preference. The devices are mechanically adjustable. Further, the pressurization of the different pressurizable compartments and vacuum chamber may be modified to allow for gradual and on-going physiological and anatomical improvements over time.

A still further object is to provide a device that can be easily cleaned after each use.

Particular embodiments of the subject matter described in this specification can be configured to concurrently apply longitudinal and lateral traction forces on the erect penis. The goal of such therapy is to reduce abnormal penile curvature while increasing penile length and girth, promoting increased blood supply and overall penile functionality.

In some embodiments, the devices described herein are configured to use the device and methods of the invention as an adjuvant therapy such as intralesional therapy for the treatment of Peyronie's disease.

One aspect provides an improved external therapy device and method for the non-invasive treatment of Peyronie's disease that overcomes the limitations of the prior art. The device is configured to treat an abnormality of the erect penis such as a bend, curve, or hourglass-shaped narrowing which can negatively affect sexual function.

Particular embodiments relate to erectogenic rehabilitation and treatment with or without concurrent Peyronie's disease. With this approach, the integrity of the cavernous tissues, including arterial blood supply, venous drainage, lymphatic channels, and innervation may be maintained or rehabilitated. These techniques can potentially prevent cavernous tissue fibrosis from precluding the return of spontaneous erections. Outward stretching of the smooth muscle fibers and the tunica albuginea may lead to increased penile girth and improvement of spontaneous erectile ability and frequency.

The present invention addresses key patient complaints and poor compliance associated with existing penile traction devices and vacuum erection control systems. The present invention provides patients a simpler, more effective and yet affordable option. In addition to being an integrated system, the component technology comprising the present invention is versatile and scalable in addressing issues related to both ED and PD.

### BRIEF DESCRIPTION OF THE DRAWINGS

FIG. 1 is a perspective partial cutaway view of the combination vacuum cylinder and dual sheath assembly device of the invention.

FIG. 2 is a cross-sectional view of the dual sheath assembly within the vacuum cylinder taken along the line A-A of FIG. 1 according to one embodiment.

FIGS. 3 and 4 are simplified cross-sectional views similar to FIG. 2 whereby the opposing eccentric balloons have been rotated within the tightening compartment.

FIG. 5 is a view as in FIG. 2, but with the eccentric balloons deflated. The tightening compartment and vacuum compartment are at atmospheric pressure.

FIG. 6 is a view as in FIG. 5, but with the tightening compartment pressurized and vacuum has been created in the vacuum compartment, drawing the user's penis P into the vacuum compartment.

FIG. 7 is a view as in FIG. 6, but with the eccentric balloon 100a pressurized and the eccentric balloon 102A deflated, shifting the vacuum compartment with the penis P therein from right to left.

FIG. 8 is a view similar to FIG. 7, but with the eccentric balloon 102a pressurized and the eccentric balloon 100a deflated, shifting the vacuum compartment with the penis P therein from left to right.

FIG. 9 is a representative longitudinal view of an actuator segment of an eccentric balloon catheter with the eccentric balloons deflated, according to some embodiments.

FIG. 10 is a representative view similar to FIG. 9 with the eccentric balloons inflated.

FIG. 11 shows a cross-sectional view taken longitudinally through an actuator unit having two actuator segments. Each actuator segment is formed of three eccentric balloons according to this particular embodiment of the present invention.

FIG. 12 shows a cutaway cross-sectional view of the distal end of a catheter shaft within a catheter housing depicting an eccentric balloon arrangement connected to the outer elastic layer within the tightening compartment

FIG. 13 is a perspective view of the inner tubular core of the catheter body illustrating the luminal grooves.

FIG. 14 is a cross-sectional view of the balloon catheter in FIG. 11 as seen along the line 8-8, showing the inflation lumens defined by grooves formed in the tubular core of the tubular body.

FIG. 15 is as in FIG. 12, illustrating further the lumen defining grooves.

FIG. 16 is a cross-sectional view of another embodiment of the tubular body in which the inflation lumens are formed within the core.

FIG. 17A is a cross-sectional view of a penis with Peyronie's disease depicting scar tissue in the dorsal aspect of the tunica albuginea.

FIG. 17B is a longitudinal view of FIG. 17A depicting abnormal curving of the erect penis due to the dorsal PD plaque.

FIG. 18A is a cross-sectional view of another penis with PD depicting scar tissue in the right upper quadrant of the tunica albuginea. The plaque involves the proximal third of the penile shaft.

FIG. 18B is a frontal view of FIG. 17A depicting abnormal curving of the erect penis towards the side of the Peyronie's plaque.

FIG. 19 is a longitudinal schematic of the erect penis of FIG. 17B within the vacuum compartment of the device depicting selective inflation of the eccentric balloons in the tightening compartment for applying contralateral and longitudinal penile traction and pulsating forces on the afflicted penis according to one embodiment of the present invention.

FIG. 20A is a longitudinal section view depicting selective inflation of opposed eccentric balloons for applying contralateral penile traction forces to treat a Peyronie's plaque.

FIG. 20B is a view similar to 19 wherein inflation of opposed eccentric balloons has been reversed in order to bend the organ in the opposite direction.

FIG. 20C is a view as in FIG. 19 wherein inflation of the opposed eccentric balloons has been reverted to the original configuration in order to create a back and forth bending sequence (see arrows).

FIG. 21A is a cross-sectional view of the penis of FIG. 20A within the vacuum compartment of the device depicting a preferred configuration of an actuator unit having three actuator segments.

FIG. 21B is a view similar to FIG. 21A depicting differential inflation of two eccentric balloons opposed to the PD plaque.

FIG. 21C is a longitudinal sectional view depicting the application of contralateral traction forces with reverse bending of the erect penis at the level of the Peyronie's plaque.

FIG. 22A is a side sectional view of the cuff having inflatable annular chambers, fitted between the tightening compartment and the vacuum compartment, according to one embodiment of the present invention.

FIG. 22B is a cross-sectional view of FIG. 22A.

FIG. 23A is a view similar to FIG. 24A, wherein the tightening compartment has been pressurized and vacuum created within the vacuum compartment drawing the penis P into an erect state within the vacuum compartment.

FIG. 23B is a cross-sectional view of FIG. 24A taken along the line D-0.

FIG. 24A-H are sectional views of the inflatable annular chambers with the user's erect penis within the vacuum compartment depicting one possible balloon inflation sequence in order to create a pressurization wave to treat erectile dysfunction.

FIG. 24A is a cross-sectional view of FIG. 24C taken along the line E-E.

FIGS. 25A-H are sectional views of the inflatable cuff of the present invention depicting sequential expansion and contraction of the annular chambers in linear sequence. According to this embodiment, two annular chambers are inflated simultaneously.

FIG. 26A is a cross-sectional view of an embodiment of a dual sheath assembly having an inflatable cuff interposed between the tightening compartment and the vacuum compartment.

FIG. 26B is a view as in FIG. 26A taken following expansion of the vacuum compartment by the user's erect penis and differential inflation of three eccentric chambers located within the inner elastic layer of the inflatable cuff.

FIG. 26C is a perspective view of FIG. 138 depicting one possible arrangement of the eccentric chambers viewed in the longitudinal plane.

FIG. 27 illustrates schematically components of a supply/control system for controlling inflation pressure and sequence to an actuator unit of the invention.

### DETAILED DESCRIPTION

The present invention generally provides improved devices, systems, and methods for the treatment of ED and PD. The invention often makes use of a conventional vacuum cylinder integrated with a dual sheath assembly of the invention surrounding a central vacuum compartment receptive to a user's flaccid penis so as to induce its erection and apply controlled longitudinal and/or contralateral constraining, deflection, or pulsation forces on the erect penis. The invention is capable of providing advantageous control over the inflation process of balloon chambers within a tightening compartment of the dual sheath assembly, thus allowing smooth and gradual changes to the degree of expansion within each pressurizable chamber over time.

An individualized treatment plan may be designed and implemented by the treating physician and/or a trained nurse practitioner. However, patient input and participation is encouraged. Air pressure within the pressurizable chambers and/or other treatment parameters such as pulsatile, vibration, or deflection control often being monitored and enhanced by measuring one or more characteristics of sensors placed within the system. Some embodiments may effect controlled rate of inflation and deflation of selective pressurizable chambers distributed circumferentially and longitudinally along the shaft of the user's erect penis, more specifically with respect to the location, degree of angulation, and direction of penile contracture in a patient with PD.

In the following detailed description, only certain exemplary embodiments of the present invention are shown as described, by way of illustration, however, it is to be understood that features of the different embodiments are exchangeable between the embodiments and may be combined in different ways, unless anything else is specifically indicated. It may also be noted that, for the sake of clarity, the dimensions of certain components illustrated in the drawings may differ from the corresponding dimensions in real-life implementations. Even though in the following description, numerous specific details are set forth to provide a more thorough understanding of the present invention, it will be apparent to one skilled in the art that the present invention may be practiced without these details As those skilled in the art would recognize, the invention may be embodied in many different forms and should not be construed as being limited to the embodiments set forth herein.

Embodiments of the present invention will now be described with reference to the drawings, wherein like reference numerals are used to refer to elements throughout. It will be understood that the figures are not necessarily to scale.

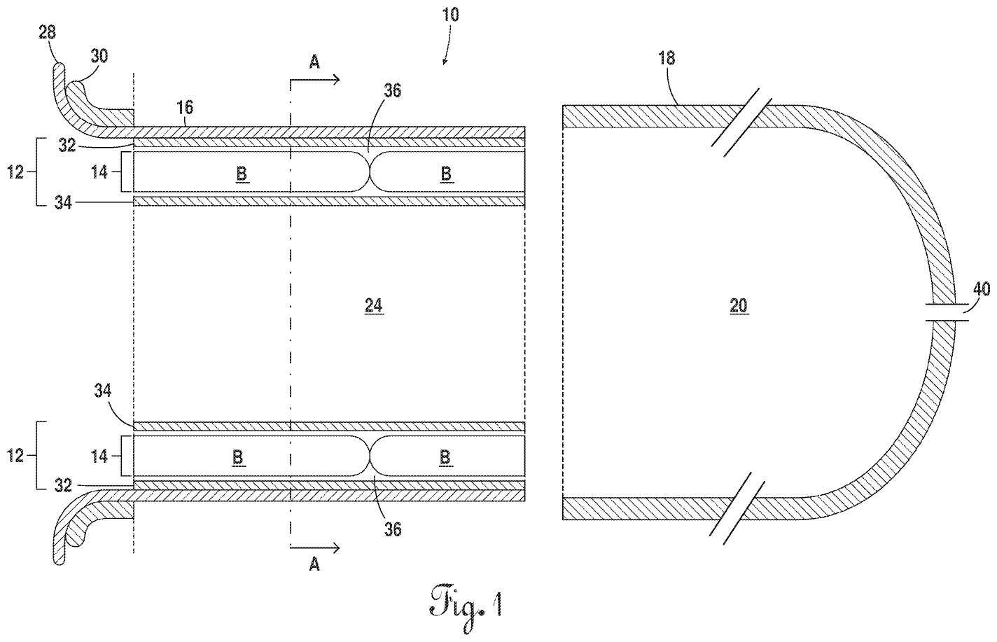

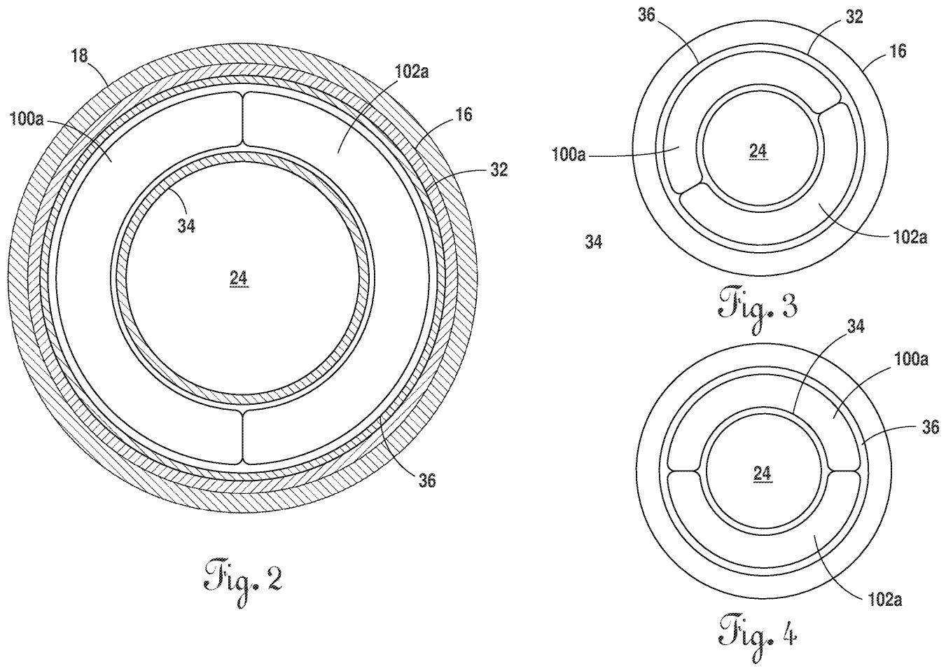

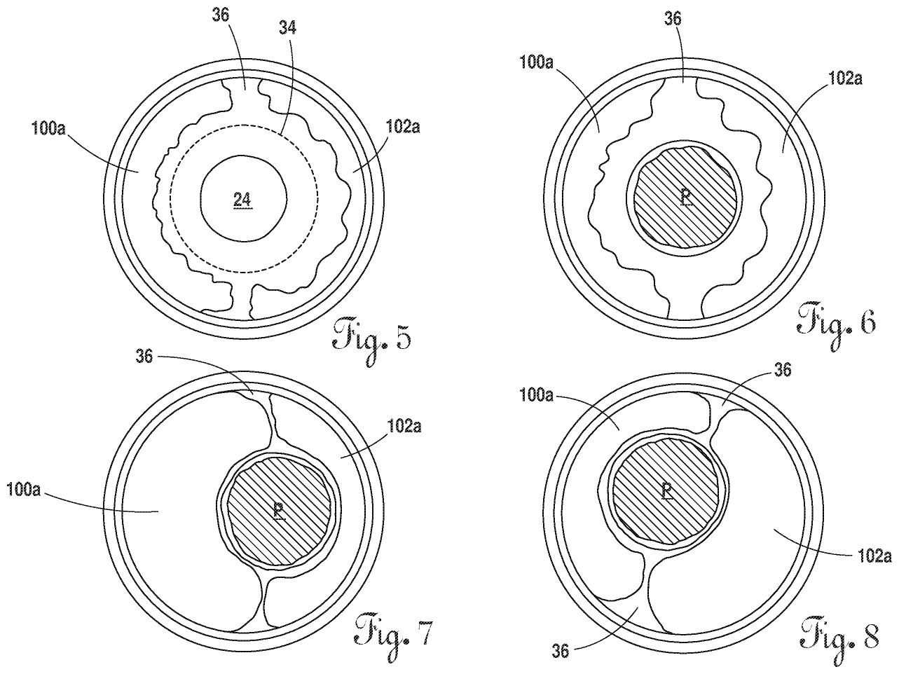

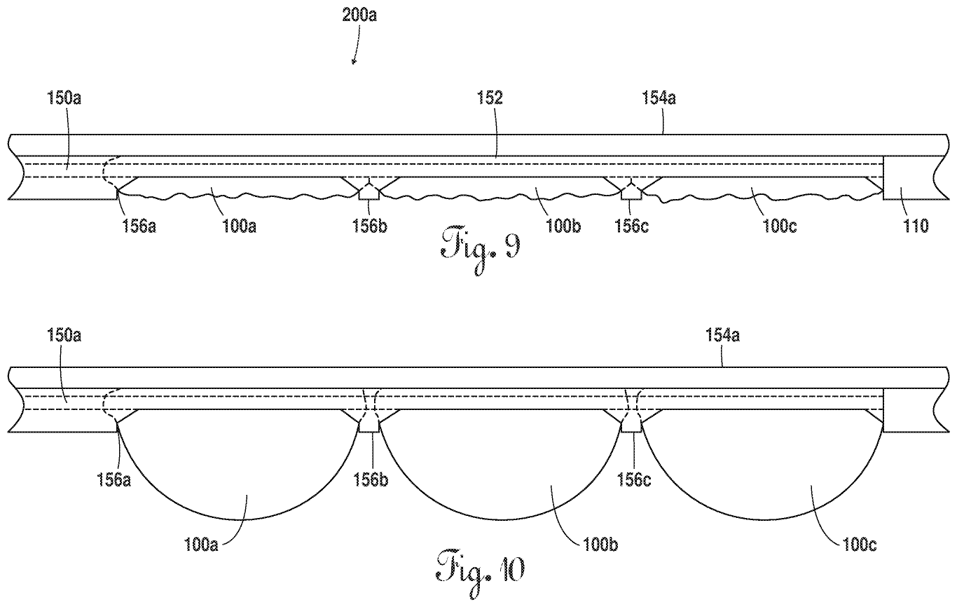

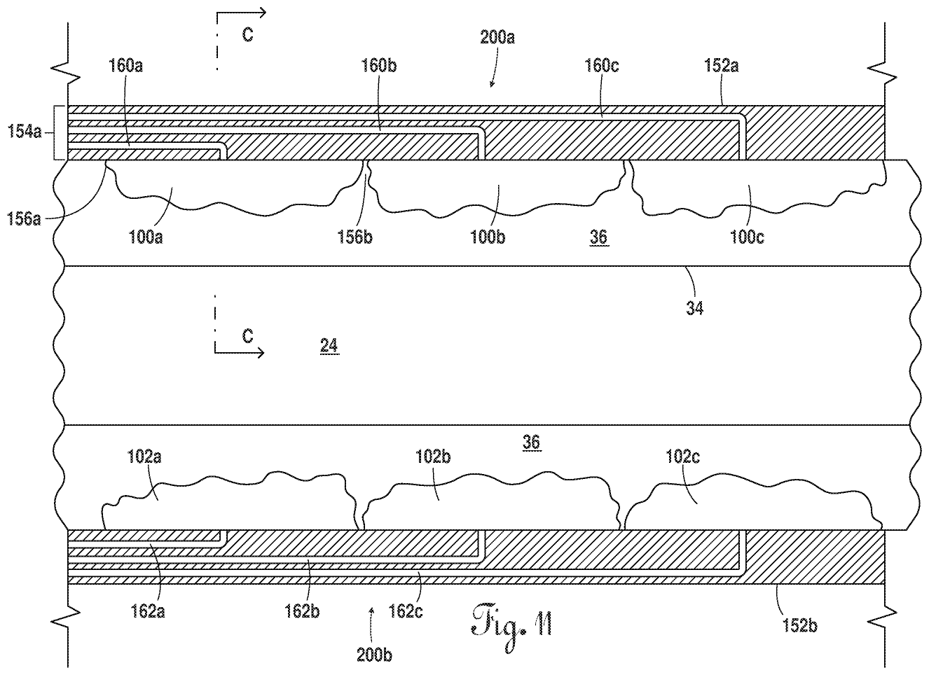

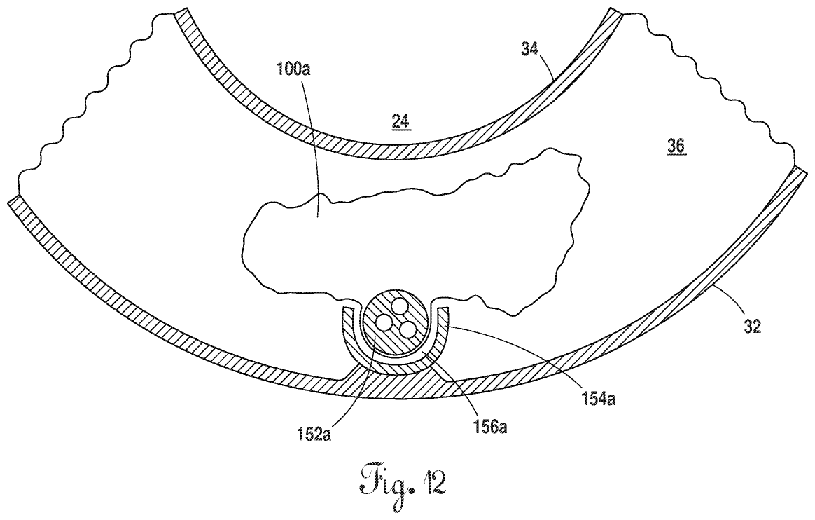

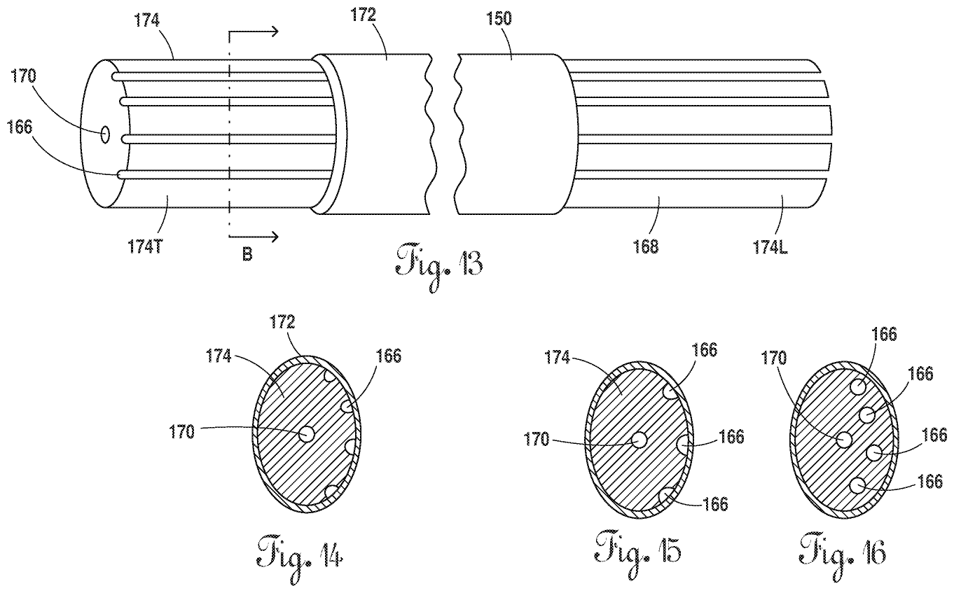

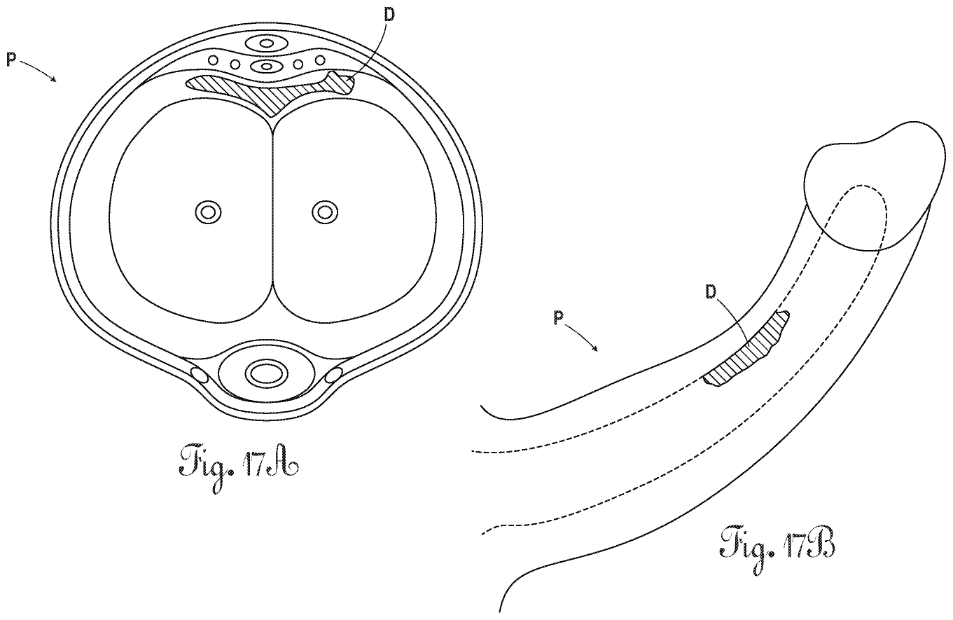

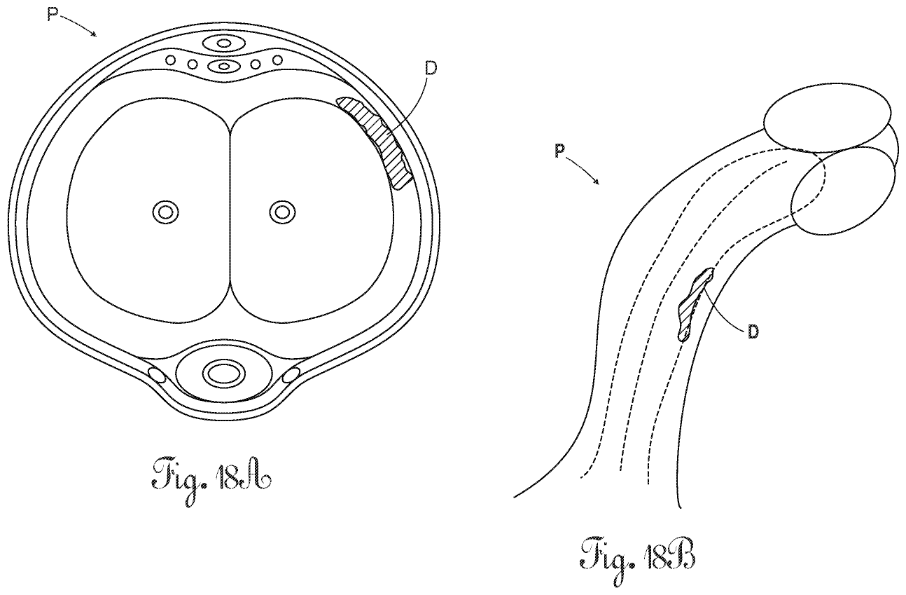

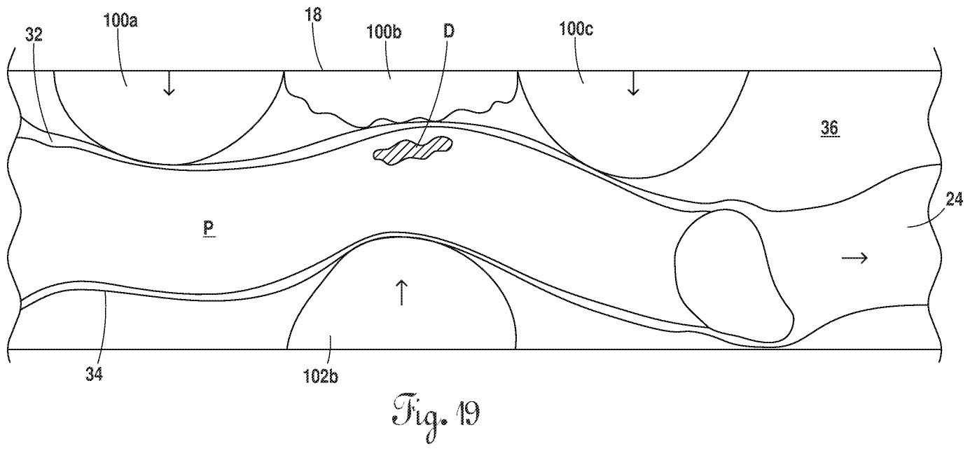

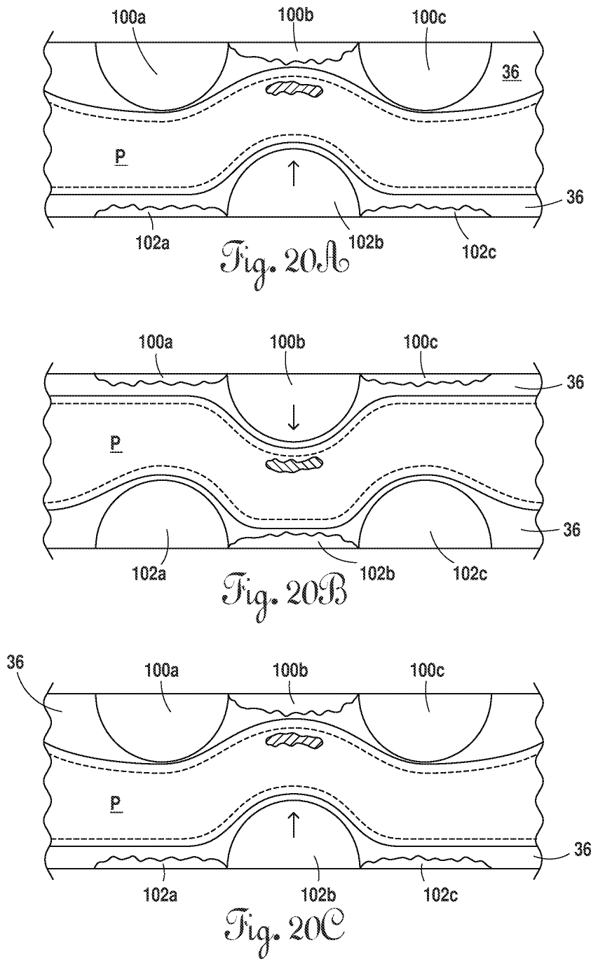

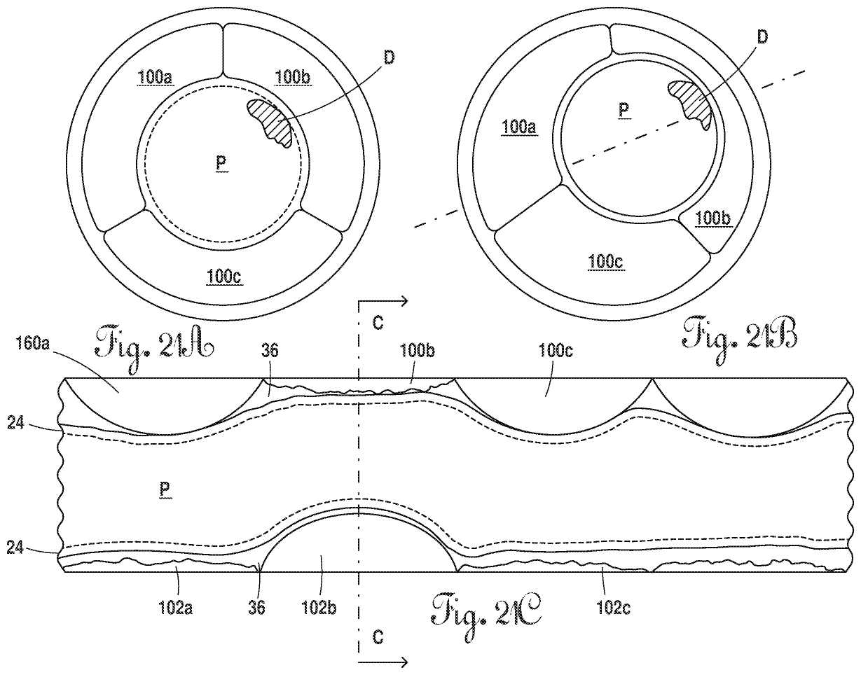

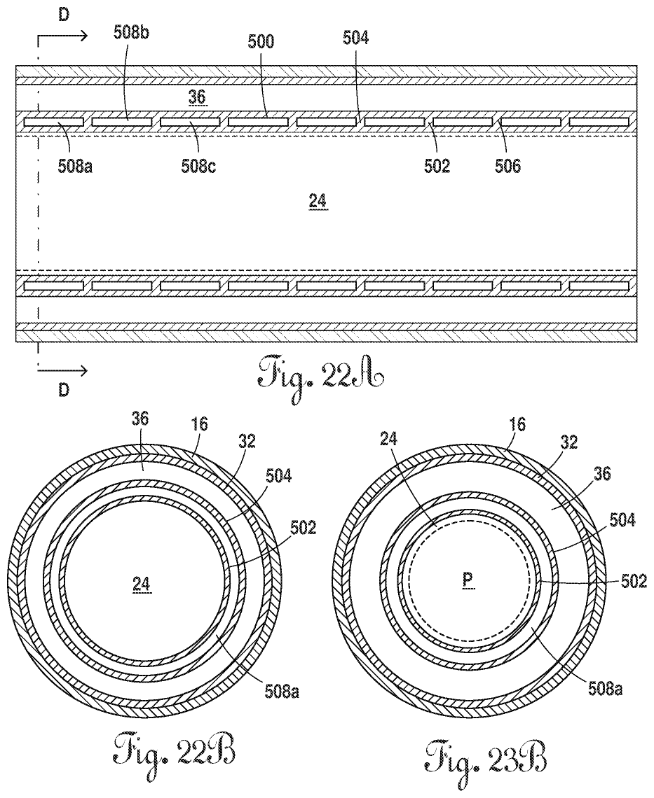

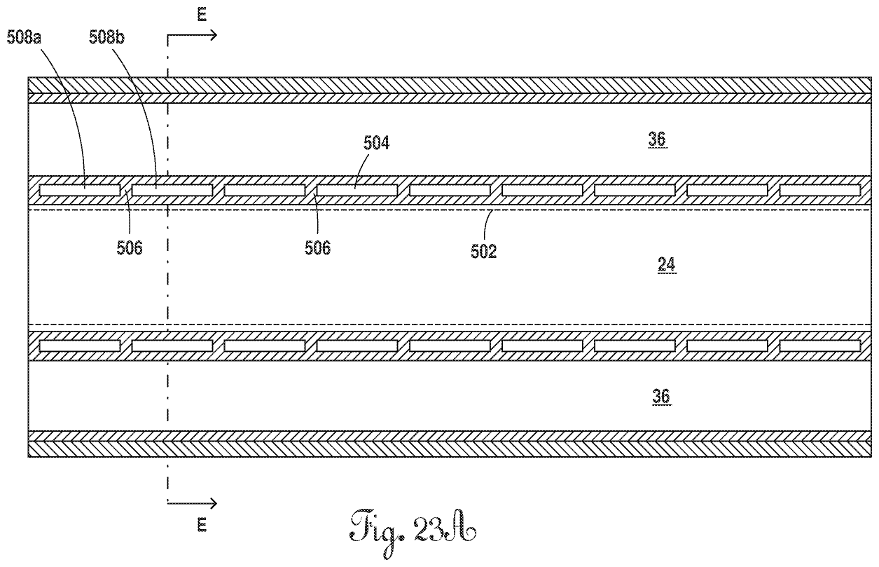

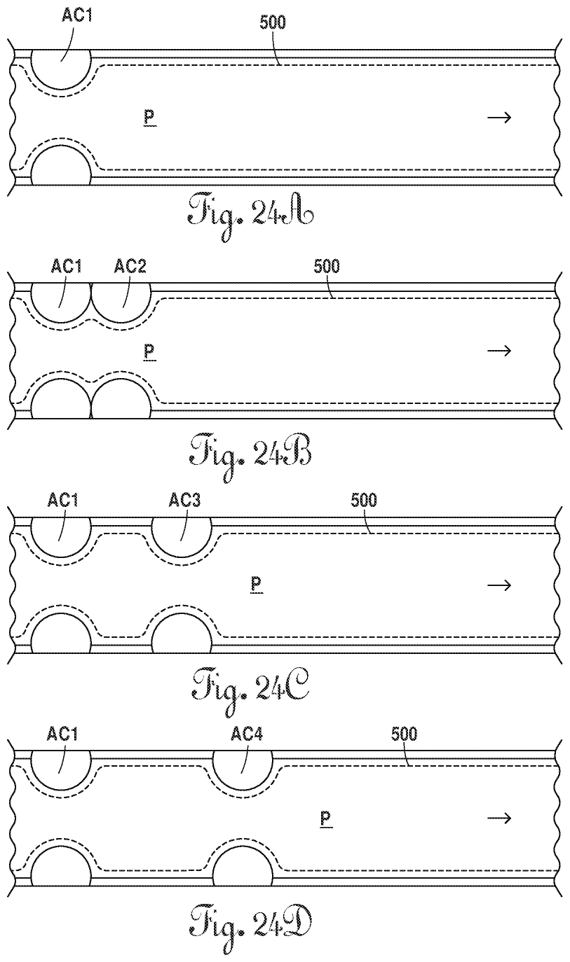

Turning now to the drawings, there is shown in FIGS. 1 and 2 a device 10 for the treatment of erectile dysfunction ED and PD.

As shown, vacuum cylinder 18 is a hollow, cylindrical tube of transparent plastic, enclosing a dual sheath assembly 12 and vacuum compartment 24 therein, to receive a flaccid penis. Vacuum cylinder 18 has a distal end for operative connection to a vacuum generating device (not shown) through nipple fitting 40, an open proximal end 22, an inside surface, and outside surface.

Device 10 includes a dual sheath assembly 12 formed of a dual sheath member 14 and, optionally, a rigid tubular member 16 that encases dual sheath member 14. Assembly 12 is reversibly slidable within the vacuum cylinder 18. In an alternative embodiment, sheath member 14 may be configured to be installed directly into vacuum cylinder 18, without use of rigid tubular member 16. Sheath member 14 thus may be self-contained, removable for washing and hygiene, and reusable by the user. Either dual sheath assembly 12 or dual sheath member 14 is slidable into the lumen 20 of vacuum cylinder 18.

Tubular member 16 may have an outward proximal flange 28. Tubular member 16 may be approximately 18 cm long, and extends along the entire length of vacuum cylinder 18. Tubular member 16 has a wall thickness of approximately 1.5-2 mm, and is formed from rigid material, such as a transparent plexiglass acrylic plastic. The flange 28 acts as a stop to movement of tubular member 16 into lumen 20 of cylinder 18 as it abuts flange 30 of vacuum cylinder 18. In one embodiment, flange 28 has a wider outer circumference than flange 30 in order to provide a fingertip contact for easy removal of dual sheath assembly 12 from its nested position within vacuum cylinder 18, such as for cleaning.

As shown in FIG. 1, dual sheath member 14 of dual sheath assembly 12 extends along the inner circumference of rigid tubular member 16, and encloses vacuum compartment 24 for receiving the male organ or penis P. Dual sheath member 14 can be formed as a fusion of two or more elastic tubular layers 32 and 34 of polymeric membrane to form tightening compartment 36. Outer layer 32 is bonded to inner layer 34 to create a tightening compartment 36. Outer elastic layer 32 of dual sheath member 14 may be bonded to the inner surface of tubular member 16. Inner layer 34 is designed to expand into tightening compartment 36 when the vacuum compartment 24 receives the user's penis P, and retracts into vacuum compartment 24 when tightening compartment 36 is inflated with air. When the tightening compartment 36 is inflated, inner elastic tubular layer 34 of dual sheath member 14 translates inwardly creating an air-tight seal around the penis P and, when pressurized, is configured to apply a radially inward force thereto. Inner elastic tubular layer 34 has a smooth inner surface along vacuum compartment 24, providing comfort to the user and optimal airtight seal when tightening compartment 36 is inflated and extended inwardly into vacuum compartment 24.

The sheath member 14 is formed of a biocompatible elastomer such as silicone having a hardness in the range of 20 to 60 microShore A and an E-modulus, preferably within the range of 6-16 MPa and more preferably in the range of 9-13 MPa, and a uniform thickness in the range of about 0.5-5 mls similar to materials used in the making of commercially available Foley catheter balloons. Such a silicone compound is commercially available from Dow Chemical Co. identified as No.S-2000. The material is responsive to low inflation pressure (e.g. about 1 atm gauge pressure); the sheath readily stretches into the desired conforming contact with penis P. The elastic layers described may be stretched up to 9 or 10 times its original dimensions while maintaining adequate tear strength. The sheath member 14 is preferably injection molded, but may also be manufactured in other ways. The tubular layers 34 and 32 may be provided by extrusion, injection molding, etc. For example, the tubular layers 34 and 32 can be formed from an extruded standard tube. This is very advantageous since extruded tubes are cost effective to produce, and also have very good properties, such as a very well-defined and even wall thickness.

Different portions of the dual sheath member 14 may be molded in a single integral piece in a suitable mold in a manner in which a particular portion of the mold is loaded with a parison of silicone rubber which will be stiff when cured, and with another portion of the mold being loaded with a parison of compatible silicone rubber which will be more elastic when cured. During the molding procedure, the portions of different stiffness merge and fuse to form a shoulderless, one-piece, integral elastic tubular sheath.

The cross-sectional stability of the device 10 may be accurately controlled. In one embodiment, the dual sheath assembly 12 is formed in a two-piece construction comprising an inner elastic tube member 34 and an outer elastic tube member 32, defining a dual sheath member 14 in which the elastic tube members 32 and 34 are extruded from silicone rubber material having different selected properties of stiffness and elasticity. The elasticity of the dual sheath member 14 may be constructed such that the elasticity of the inner elastic tube 32 contralateral to a Peyronie's plaque is substantially less (or more) than the elasticity ipsilateral to the plaque D. The materials of the sleeve are chosen to be physiologically compatible, and which do not deteriorate from contact with body fluids over time.

Still, another object of the invention is to provide a dual sheath member 14 whereby portions of the sheath are deliberately aligned with respect to the position of the abnormal penile curvature in a patient with PD such that controlled biasing pressures in the vacuum compartment 24 and the tightening compartment 36 are configured to exert a lateral bending force on the user's penis P to provide treatment for PD.

Device 10 is customizable and adjustable so that a particular patient having unique anatomical features and/or physiologic aberrations related to ED and PD may be treated appropriately. In this manner, the particular configuration of dual sheath member 14 may be built into device 10 without necessarily altering the rest of the device components. In addition, the physician may be able to set the treatment protocol on the supply/control assembly 400, FIG. 27 best suited for a particular patient without necessarily altering the hardware of the assembly.

FIGS. 2, 3, and 4 are cross-sectional views of device 10 taken at A-A of FIG. 1. Tightening compartment 36 is annular in configuration and is defined by outer elastic tubular layer 32, which is fixed, and inner elastic layer 34, which is mobile inwardly and outwardly depending on the state of pressurization of the tightening compartment 36, relative to pressurization of vacuum compartment 24. In various embodiments of the present invention, a plurality of pressurizable chambers or balloons are positioned within tightening compartment 36 which, when selectively inflated or deflated can differentially expand or contract the tightening compartment, and exert selective straightening, stretching, or bending shape control on the user's erect penis P within the vacuum compartment 24 as will be discussed in more detail. In typical applications, balloons, such as balloons 100a and 102a will be positioned in an opposing relationship within tightening compartment 36 as shown in FIG. 2. A plurality of balloons (usually 3) may be arrayed in tandem along the longitudinal plane of a catheter such as 100a, 100b, 100c, as shown in FIGS. 9, 10, and 11

In FIG. 2, balloons 100a and 102a are arranged in opposition to each other within tightening compartment 36 with respect to the sagittal plane of device 10. In FIG. 3, balloons 100a and 102a are arranged in an oblique plane to the longitudinal axis. Any degree of rotation of balloons 100a and 102a along the longitudinal axis are within the scope of the present invention, and this has relevance in the treatment of various positions of Peyronie's plaque D as will be discussed further. In FIG. 4, the balloons 100a and 102a are arranged in a top and bottom relationship to each other.

In FIG. 5, both tightening compartment 36 and balloons 100a and 102a are in a deflated state. Vacuum has not been applied within vacuum compartment 24. Accordingly, inner elastic layer 34 is in its relaxed state, and vacuum compartment 24 has a narrow diameter.

In FIG. 6, vacuum has been applied within vacuum compartment 24 drawing the user's penis P into an erect state, increasing the size of the vacuum compartment 24, stretching inner elastic layer 34 outwardly, and passively decreasing the size of the tightening compartment 36. In some applications, tightening compartment 36 may be actively pressurized at relatively low pressure to augment the vacuum air seal between inner elastic layer 34 and the user's penis P.

In other applications, tightening compartment 36 may be actively pressurized in order to exert a uniform lateral inward force on the inner elastomeric tube 34, preventing excessive lateral swelling of the user's organ, while increasing levels of a stretching vacuum force are exerted longitudinally on the erect penis P aimed to achieve penile lengthening exercises if desired.

In FIG. 7, both balloons 100a and 102a have been pressurized within tightening compartment 36. However, balloon 100a has been pressurized to a higher-pressure level than balloon 102a. The unequal balloon 100a expansion biases inner elastic layer 34, including vacuum compartment 24 with the user's penis P therein from left to right. Each chamber expands radially and axially when inflated, but eccentrically inwardly towards the longitudinal plane of the vacuum compartment.

In FIG. 8, balloon 102a has been pressurized to a higher level than balloon 100a and the organ P has been shifted from right to left. Note the oblique placement of the balloons in the axial plane within the tightening compartment. This has practical applications for targeted stretching of a Peyronie's plaque in certain applications as will be shown later

### Inflatable Chamber System Overview

In accordance with the invention, a system is configured to permit sequential, such as intermittent and repeated inflation and deflation of a series of expandable chambers within the tightening compartment 36 of dual sheath member 14. As shown best in FIGS. 9-11, expandable chambers may be in the form of (I) an assembly of eccentric balloons 100 connected to outer elastic tubular layer 32 or inner elastic tubular layer 34, (II) a cuff having annular chambers 502 integrated with inner elastic tube 34 as will be discussed in more detail, (III) a cuff integrated with inner elastic tube 34 having inflatable eccentric chambers 600. Adjacent chambers in the serially arranged annular chamber configuration may be fluidly connected or unconnected. In the eccentric balloon configuration, the adjacent balloons are independently connected to the fluid source (See FIG. 27). A fluid source (FIG. 27) is attached to one end of the set, such that the chambers inflate sequentially. The system includes a fluid source, a fluid circuit and control system unit 400 to control and modulate flow of inflation fluid to and from a plurality of balloons arrayed along at least two diametrically spaced sections of a tightening compartment 36 of a dual sheath assembly 12 wherein the balloons can be semi-automatically inflated and deflated. Additionally, safety measures are provided to prevent overinflation of the balloons, thus mitigating the risk of penile injury.

In exemplary implementations of this invention, change in curvature of the inner elastomeric tube 34 provides a range of penile deformations, controlled compression, and enhanced elongation that provide the treating physician a range of options for the treatment of erectile dysfunction and Peyronie's disease. Controlled compression, sequential or wave-like pressurization by the chambers, maintaining the pressure in each chamber for a predetermined period, etc. are a few of the possible options that may be manipulated in the present invention.

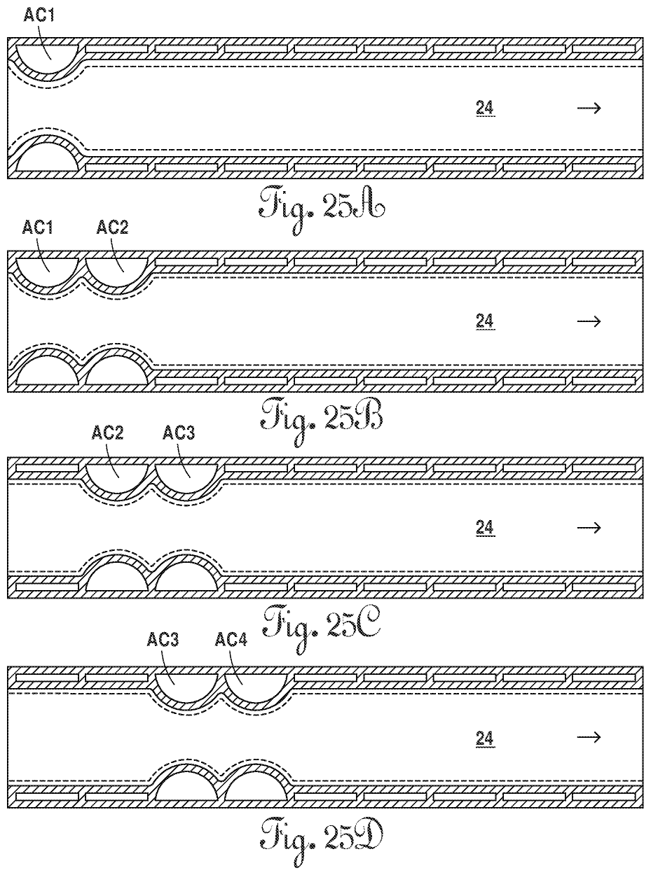

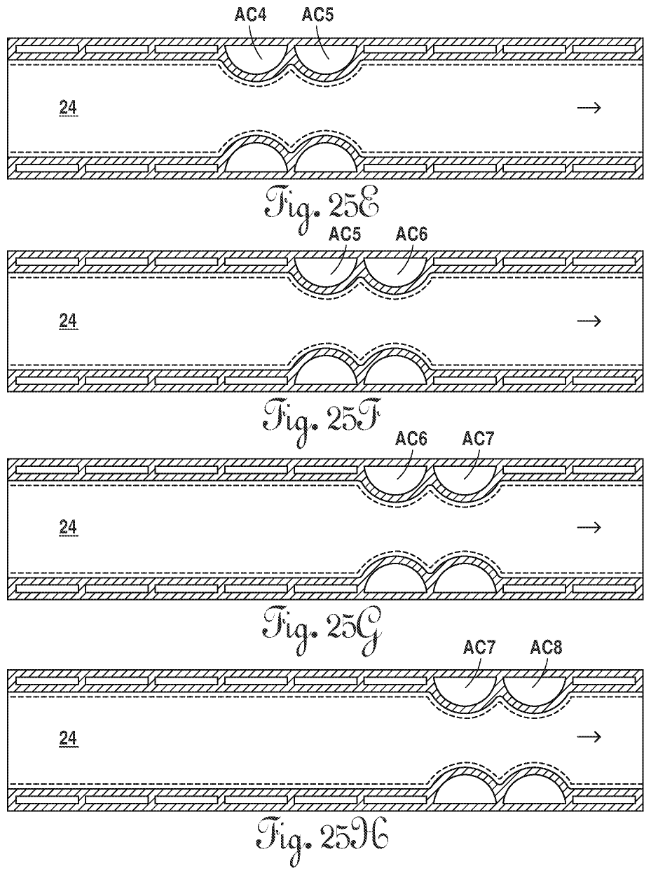

Referring to FIG. 27, in exemplary implementations of this invention, a supply/control system 400 includes a controller 191 and an actuator unit 300 that controls the shape of the user's erect penis P within the vacuum compartment 24 of the dual sheath assembly 12 of the device 10 of the present invention. In some embodiments, the actuator unit 300 includes a plurality of actuator segments 200 embedded within (see FIG. 11) the tightening compartment 36 of the dual sheath member 14. Each segment includes at least three balloons (100a, 100b and 100c) arranged in tandem. In other embodiments, the actuation of unit 300 includes the use of an inflatable cuff 500 (see FIG. 22A) interposed between the tightening compartment 36 and the vacuum compartment 24. The cuff 500 is provided with a plurality of individually expandable annular chambers 502 (see FIG. 22B) arrayed parallel to one another in the longitudinal plane. In either embodiment, when an expandable chamber is inflated, the overall shape of the tightening compartment 36 bends and is transformed in areas adjacent the relatively more flexible and stretchable inner elastic layer 34 of tightening compartment 36. For example, controlled multilateral expansion and contraction of eccentric balloons within the tightening compartment 36 may be configured to exert bending, stretching, and traction force on an erect penis P afflicted with PD, specifically to treat a Peyronie's plaque (with or without intralesional therapy).

In some implementations of this invention, dynamic control of penile curvature, elongation, and increase in girth is determined by two factors: first, the balloon pattern i.e. the size and distribution of the pressurizable balloons in the diametrically spaced sections and longitudinally along the tightening compartment 36. Several factors of the balloon pattern may be varied such as size and location of the balloons. Laying out the balloons diagonally or spirally forces generated helically distributed forces instead of simple linear curving in a single plane. Second, fluidic pressure control may require a fluid distribution for sequentially, fluidly pressurizing the balloon chambers, maintaining the pressure in each chamber for a predetermined period and thereafter exhausting the fluid pressure from the chambers. The fluid distributor of controller 191 may perform this pressurization of the chambers in the dual sheath member sequentially in a proximal to distal direction to thereby propel blood circulation within the user's penis P towards the glans.

For example, embedded eccentric balloons within the inner elastic layer 34 may be arrayed in columns, and each column of balloons can be inflated separately. The size, shape, frequency, and sequence of balloon arrangement can be varied. Pumping and vacuuming fluid in separate columns and individual balloons can be varied at different times. The combination of the three factors is capable of communicating different types of information, such as directional signals and speed.

In some implementations of this invention, (a) sensors (not shown) embedded in the dual sheath member 14 detect large-scale changes in shape, fluid pressure or membrane stretching (b) a multi lumen catheter, (as best shown in FIG. 11) embedded in the surface of the inner elastic layer or along selected eccentric balloons may sense local surface deformation with high sensitivities. The cause of shape deformation can be internal fluidic pressure or the user's input. Advantageously, an elastomeric interface can undergo a wide variety of manipulations by the user to deform the penile curvature, length, or girth, such as by pushing, stretching, bending, or squeezing, etc.

The dual sheath member 14 may function as a multi-segment pressurized actuator. A plurality of eccentric balloons arrayed in tandem within at least two diametrically opposed sections of a tightening compartment of the dual sheath member 14 are configured to produce a variety of actuation motions directed at a user's erect penis P within a vacuum compartment 24 when the eccentric balloons 100 are selectively pressurized and depressurized. Some actuation motions may be generated by the eccentric balloons or annular chambers expanding and contracting in linear sequence. Other actuation motions are configured to generate selected bending, extending, expanding, stretching, twisting, and combinations thereof.

A multi-segment pressurization actuator may be used, e.g., to facilitate bending of an erect penis of a user suffering from PD.

Embodiments of the actuator can be programmed during the manufacturing phase to achieve a wide range of motions.

Individually expandable chambers or balloons 100 may be inflated separately by fluid pressure. A multi-port flexible conduit 180, FIG. 27 connected to the dual sheath assembly 12 of the multi-segment pressure actuator unit 300, FIG. 11 having individual ports for each chamber. Fluid pressure may be supplied through the conduit by a pump through a circular valve plate allowing the chambers to expand and contract in linear sequence.

The gradual, slow inflation of the pressurization balloons should occur over a period of minutes, and this timing may vary according to this specific application.

One mode of peristaltic wave is shown in FIGS. 25A-H. For the sake of simplification, only one actuator unit 300 (FIG. 27) is shown, although in a specific application several units 300 are more likely utilized. As shown, individual expandable chambers 508 are distended separately by fluid pressure. Fluid pressure may be supplied by an electrically operated pump, through circular valve plate (not shown) allowing the chambers to expand and contract in linear sequence. When a flaccid penis P is placed in a vacuum chamber 24 of the invention, and vacuum is applied to induce an erection, successive expansion and contraction of the annular chambers 508, blood is forced to the end of the organ through the successive expansion and contraction of the balloons within the tightening compartment.

Referring to FIG. 27, a functional flow diagram depicts a series of valves that provide selective inflation of actuation unit 300. After balloon 100a is expanded, the pressure within the balloon 100a reaches a preset value, fluid moves through valve 190a into balloon 100b which expands as it fills as shown in FIGS. 20A-C. When balloon 100b is filled, pressure builds up to a higher preset value, and fluid moves from balloon 102b through a second valve to balloon 100c which then fills and expands as shown in FIGS. 20A-C.

In exemplary implementations of this invention, a shape controller 191 in FIG. 27 controls the shape of the user's erect penis P within the vacuum compartment 24 as the tightening compartment 36 differentially inflates within the dual sheath member 14. Referring to FIG. 19, an inner elastomeric tube 34 undergoes controlled changes in shape. A rigid outer vacuum cylinder 18 contains outward expansion of the dual sheath member 14 and, when the dual sheath member 14 is inflated, the overall shape of the member is reconfigured in areas adjacent the inner elastic tube 34 along the vacuum compartment 24.

A shape output is computationally controllable through fluidic pressure and pre-determined arrangement of the diametrically spaced sections and the configuration and the distribution of the eccentric balloons. The tightening compartment 36 undergoes isotropic (uniform in all directions) or anisotropic (directionally dependent) deformation. Optionally, the tightening compartment 36 is provided with input sensors and active output sensors.

Shape change can be used to convey information to the physician and to the user as a type of display. Either shape states of the erect penis within the vacuum compartment 24 or changes in shape state may convey information. For example, resistance to bending at a certain location (or change in angulation) can provide a haptic channel for representing or communicating information. The soft composite tissues of a user's penis, in various states of erection can display dynamically controllable shape patterns that can vary between users and for the same user over time.

Optionally, a sensing layer (not shown) such as conductive thread is included in the elastomeric layers 32 and 34 or in the fabric to sense input or output. For example, a conductive material may comprise liquid metal, conductive thread, conductive fabric, or metal wire.

Each component of the dual sheath member 14 may include membranes of different elasticity, thickness, and durometer. These membranes such as the inner elastic layer 34 or in the eccentric balloons can enhance or modify the deformations caused by fluidic pressure actuated inflation.

In particular applications, related to both ED and PD tensioning can be applied to the erect penis by the inner elastic layer 34 enveloping the erect penis as the penis is being stretched longitudinally by the vacuum distal to the penis. A lateral traction member may include a set of expandable eccentric balloons placed in the tightening compartment 36 of the dual sheath assembly 12. The eccentric balloon placement within the tightening compartment 36 at the level of a Peyronie's plaque D in a particular patient may be reconfigurable into an optimal configuration to achieve effective stretching of the Peyronie's plaque D, especially when coordinated with intralesional therapy.

Tension indicators and/or sensors (not shown) may be placed at different locations along the inner elastic layer 34, that provide to the controller 191 an indication of the degree of longitudinal and lateral traction force. Fluid pressure within the adjacent expandable chambers and membrane tension sensors in the inner elastic layer 34 may be provided to allow adjustment by physician or user to two or more tension levels.

In another implementation, the devices of the invention for applying mechanical therapeutic action on a user's erect penis P includes individualized strategic placement of the eccentric expandable chambers at the level of the Peyronie's plaque D, as well as proximal and distal to the plaque D in order to render the most effective lateral bending and traction force to the erect penis P at the level of the lesion.

### I: Eccentric Balloon Catheter Assembly for the Treatment of ED and PD

Turning now to FIGS. 9-12, there is shown in FIG. 9 an actuator segment 200 that may be fitted within tightening compartment 36 of dual sheath member 14 connected to either outer elastomeric tube 32 or inner elastomeric tube 34. Actuator segment 200 includes an elongate and flexible catheter 150 formed from an elastomeric rubber. The distal end of the catheter 150 is molded in one integral piece to include a balloon portion 152. In one embodiment, at least three balloons 100a, 100b, 100c are formed on the balloon portion of catheter 150. Catheter 150 is fitted within an elongate catheter housing 154 having three cavities or windows 156a, b, c within a distal portion of elongate catheter housing 154 near the balloon portion 152 of catheter 150. Each cavity exposes a portion of the interior of the catheter housing 154. Each of the balloons 100a, b, c may be disposed within the catheter housing 154 within the corresponding cavity such that when the balloon is deflated or mostly deflated, the balloon is contained within the radius of the catheter housing 154. When the balloon is inflated, the balloon expands and extends through the cavity beyond the periphery of the housing 154.

The catheter elongate housing 154 is constructed of a firm biocompatible thermoplastic elastomer, e.g. polyurethane, polyethylene or nylon, typically with an outside diameter in the range of 20-30 French. Catheter 150 is of a similar but smaller size and fits within catheter housing 154. The wall of the catheter housing 154 may be reinforced with a wire mesh or possibly a thin metal tubing in the region of the cavities 156a, b, c in order to bias the balloons 100a, b, c eccentrically out of the corresponding windows without deforming the housing 154.

Moreover, in some embodiments, the balloon portion 152 of catheter 150 may be eccentrically located within housing 154, such that when inflated, the balloons 100a, b, c inflate generally outward in one direction from the axis of the housing 154. In some embodiments, the balloons and/or catheter 150 may be partially bonded within the housing 154 such that the balloons and housing are partially fixed to one another.

In FIG. 10, balloons 100 a, b, c are shown inflated and extending from within cavities 156 a, b, c. In FIG. 11 balloons 100 a, b, c and 102 a, b, c may have diameters of about 2 cm-3 cm when inflated, according to one embodiment. In some embodiments, balloons 100 a, b, c and 102 a, b, c may have inflated diameters up to about 4 cm and as little as 0.5 cm. In some embodiments, balloons 100 a, b, c and 102 a, b, c may comprise elastic tubing with sealed ends. The balloons, for example, may comprise any type of polymer such as nylon, Teflon, urethane, polyethylene, or a mixture thereof. The balloons, in some embodiments, may be 2 cm or 3 cm in length each. In some embodiments, the balloons may be partially inflated, completely inflated, or any level of inflation/deflation.

In FIG. 11, the balloon portion 152a of catheter 150a is shown with the balloon chambers 100a, b, c in deflated condition. Separate inflation lumens 160a, 160b, and 160c are provided in catheter 150a, which open respectively in the chambers 100a, b, c. Contralateral to catheter 150a within tightening compartment 36 is catheter 150b having a balloon portion 152b and balloon chambers 102a, b, c. Separate inflation lumens 162a, b, c are provided in catheter shaft 150b which open respectively in the chambers 102a, b, c. Referring to FIG. 27, at the proximal end of catheters 150a and 150b control valves are suitably designed to inflate each chamber independently (simultaneously) or in an incremental mode by way of control valves 190a, b, c.

In FIGS. 11 and 12, actuator unit 300 (FIG. 27) depicts actuator segments 200a and 200b within the peripheral aspect of tightening compartment 36 bonded or otherwise connected to outer elastic layer 32. In other embodiments, actuator segments 200a and 200b may be connected to or otherwise incorporated into inner elastic layer 34 (claim) that way, the actuator segments 200 and the eccentric balloons 100 would translate inwardly or outwardly as the pressurization of tightening compartment 36 and vacuum compartment 24 is varied.

FIG. 12 shows a cross-section of balloon portion 152a within cavity 156a cut through a portion of the periphery of catheter housing 154a. Catheter housing 154a is connected, bonded, or otherwise integrated to outer elastomeric tube 32. Cavity 156a may simply be cut from one side of the periphery of housing 154a. In one embodiment, the cut portion of housing 154a may be reinforced by a thin crescentic layer of plastic or metal that biases the expansion of the balloon eccentrically towards the central longitudinal axis of the vacuum compartment 24.

In some embodiments, when the balloon 100a is deflated, it retracts into the cavity 156a. In some embodiments, catheters 150 a, b may be coupled with a fluid pump such as air. The balloon may be inflated by pumping the fluid into each balloon independently and controllably. In some embodiments, balloons 100 a, b, c may be deflated by removing the air or liquid from each balloon using the pump. In some embodiments, because the balloons are pressurized when inflated, balloons 100 a, b, c may be deflated by purging the air or liquid from each balloon with or without using the pump. For example, purge valves may be coupled with each balloon lumen that allows the air or liquid within an inflated balloon to be released when the purge valve is opened.

Referring now to FIGS. 13-15, the catheter includes an elongate tubular body 150, a tip balloon assembly (not shown), an inner core 174, and a port (not shown) 158 attached to the trailing end of tubular body 150. Preferably, all of the elements of the catheter 150 are fabricated from silicone rubber because of its inert, non-wetting surface, durability, variable stiffness, and other desirable characteristics.

The balloon portion 152 of actuator segment 200 may be formed in a mold (not shown) having a cavity of corresponding shape. Alternatively, the balloon portion 152 may be produced by an extrusion process. The silicone rubber materials for the balloon portion 152 and the inner core 174 are completely compatible with each other, and display the same desirable properties except that the balloon portion 100 will be substantially more elastic than the inner core portion 174. For example, the balloon material may be stretched up to 10× its original dimensions while maintaining adequate tear strength. In contrast, the inner core portion 174 may be made from a silicone rubber compound which may be half as elastic but of higher durometer. At least three balloon membranes 100a, b, c may constitute the balloon portion 100. The balloons 100 and the inner core portion 174 may be fused together into a single, integral unit during the molding process (or assembly process).

When the balloons are collapsed, the outer diameter of the molded balloon portion 152 is the same as the trailing portion so that after the molding process, the balloon portion 152 is, in effect, a smooth, continuous, shoulderless, and integral rearward extension of the outer sleeve 172, although having substantially more elastic properties.

Referring again to FIGS. 13-15. The trailing, elongate shaft of catheter 150 is of 2-piece construction and includes an inner core 174 and an outer sleeve 172 which surrounds the inner core 174. The uncovered portion of inner core 174 is longer than the outer sleeve 172 at both ends, and extends forward beyond the leading end of the outer sleeve 172, as noted at 174L in FIG. 14. Similarly, the proximal end of the inner core 174 extends proximally beyond the trailing end of the outer sleeve 172 in like manner as noted at 174L in FIG. 13.

The forward or leading portion 174L of inner core 174 extends into the balloon portion 152 whereby the inner core 174 is adhesively bonded to a shoulder portion 154 of the balloon portion 152 to create balloon chambers 100a, b, c in FIGS. 9 and 10. [0124] The wall thickness of the outer sleeve 172 is the same as the thickness of the balloon membrane so that when the balloon membrane and the sleeve 172 butt against each other, they will define a smooth, shoulderless, and uninterrupted external surface.

The front and rear ends of the balloon portion 152 may be cemented to the inner core 174 to define a plurality of balloon chambers. The balloon portion 152 may be cemented at a plurality of locations along the inner core 174 to create a set of serially arranged inflatable chambers, the adjacent chambers being fluidly unconnected, and independent fluid sources such that the chambers may be inflated sequentially.

The inflatable chambers (for example 100a, b, c) of the balloon portion 152 of actuator segment 200 FIG. 11 may be inflated and deflated through lumens 164 FIGS. 13-15, which extend through catheter 150 and communicate the eccentric inflatable balloon chambers with port 158.

FIGS. 13-15 show a preferred lumen construction which is usable particularly in connection with core and sleeve structure of the catheter body 150 described above. In an exemplary implementation of the eccentric balloon structure of this invention, inner core 174 may be extruded in an oval configuration during an extrusion process.

Significant advantages result from the use of silicone polymer in the construction of the inner core 174, outer sleeve 172, and balloon 100, especially cementing or bonding the different components, and to the relative ease and reliability of using the same material. For example, the inner core 174 may be extruded from a silicone rubber compound having relatively high degree of stiffness as compared to the material of the outer sleeve 172, so that the combination of materials may provide the ideal result and stiffness for the composite catheter 150. The outer sleeve 172 may be formed from silicone having different elasticity from balloon membrane 100. Preferably, the material from which the sleeve 172 is made is somewhat less elastic than the balloon membrane 100 to ensure that the fluid pressure in the inflation lumens 164 will not cause the sleeve 172 to expand during pressurized inflation of the balloons.

The trailing end of the catheter 150 includes a port 158 which may be molded, at least partially, in a single piece from silicone rubber.

The inner core 174 and the outer sleeve 172 portion may be extruded separately of silicone of different durometer. A plurality of external grooves 166 may be formed along the surface of inner core 174. Before the sleeve 172 and the core 174 are cemented, the grooves 166 are threaded with wires (not shown) which will ensure that the cement will not block the lumens 164. When the wires are removed from grooves 166, lumens 164 are formed as shown in FIGS. 15 and 16.

FIG. 16 shows an alternative inflation lumen configuration in which the lumens 164d are formed entirely within the wall of the inner core 174. These inflation lumens 164d may be formed in the inner core 174 during its extrusion. A separate central lumen 170 communicates with tightening compartment 36.

The trailing end of the catheter includes a port assembly which may be molded in a single piece from silicone rubber.

FIG. 17A is a cross-sectional view of a penis P of a patient with Peyronie's disease having a plaque D in the dorsal aspect of the tunica albuginea.

FIG. 17B is a side view of FIG. 17A showing the Peyronie plaque D in the mid to distal third of the penis P, associated with 30 degree cephalad curvature.

FIG. 18A is a cross-sectional view of a penis P of a different patient with Peyronie's disease having a Peyronie's plaque D in the right upper quadrant of the tunica albuginea.

FIG. 18B depicts abnormal curving of the erect penis P obliquely towards the Peyronie's plaque D, which involves the proximal third of the erect penis P.

Each of these patients require a different expandable balloon configuration arranged in an individualized manner in order to achieve an optimal treatment plan as will be illustrated in the following figures.

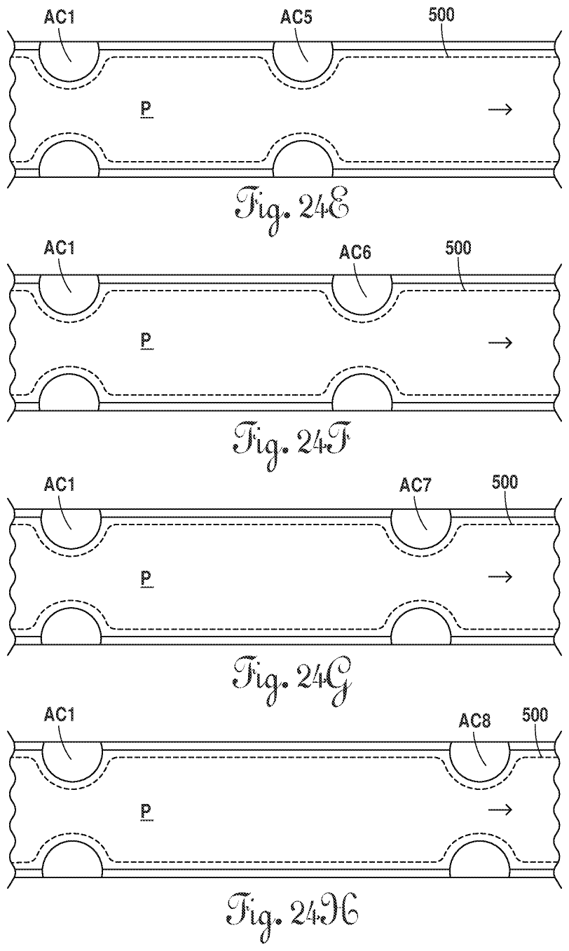

Referring to FIGS. 19, 20A-C and 21A-C, at least three expandable chambers 100 and 102 are required to secure the penis P in position and to render effective therapeutic tissue reconfiguration at the level of the lesion: three along the longitudinal axis, and three within the axial plane. Depending on the location of the lesion in the axial or longitudinal planes, additional expandable chambers 100 and 102 may be installed in the device to reduce the likelihood of inadvertent axial slippage or rotation of the user's erect penis P within the vacuum compartment 36 during the pressurization as shown in FIGS. 21A-C.

Referring specifically to FIGS. 20A-C, a back and forth lateral traction effect may be achieved by altering the inflation/deflation cycle on both sides of a Peyronie's plaque D. This may effectuate a simple back and forth bending movement at different pulsation speeds or degrees of traction forces. Alternatively, a pulsating or vibration process may be opted for if desired.

Particular embodiments of the present invention can be configured to vary the degree of longitudinal traction forces within the vacuum compartment 18 while the penis P is in a state of induced erection, and while applying concurrent lateral traction or constraining forces thereto by expandable chambers placed in the tightening compartment 36. In addition, the tightening compartment 36 may be selectively pressurized, aside from the eccentric balloons 100 and 102, to bias the inner elastic layer circumferentially for more effective stretching, bending, or for enhancing blood flow to the penis P. Hence, the alleviation of PD signs and symptoms, the resurrection of erectile vigor and frequency, and the increase in penile girth and length can result from the use of a single versatile device of the present invention. Since the patient frustration and dissatisfaction issues related to PD and ED are chronic and often coexist in many patients, the devices of the invention are geared to allow for gradual and ongoing anatomical and functional improvements that are readily perceivable and quantifiable by the provider and patient alike. Furthermore, the improvised controller of the device is amenable to individualized treatment plans that can be devised and implemented, thereby incentivizing the patient and enhancing treatment results.

### II: Cuff Having Inflatable Annular Chambers to Treat Erectile Dysfunction

In one embodiment of the present invention, illustrated in FIGS. 22A, B and 23A, B an inflatable cuff 500 is interposed between tightening compartment 36 and vacuum compartment 24 of dual sheath assembly 12. Inflatable cuff 500 may be considered to assume some of the properties of inner elastic layer 34 of the eccentric balloon embodiment described earlier in this specification. As shown in FIGS. 22A-B, and 23A-B inflation cuff 500 moves outwardly as vacuum compartment 24 expands by the user's erect penis P, and inwardly as the pressure within tightening compartment 36 increases. As the tightening compartment 36 is inflated and pressurized, inflatable cuff 500 is urged inwardly towards vacuum compartment 24, creating a vacuum seal and conforming fit with the penis P therein. The cuff 500 is provided with a plurality of volume expandable annular chambers arranged parallel to one another.

Referring to FIGS. 22A and 22B, cuff 500 is comprised of an inner circumferential layer 502 formed of a thin, stretchable elastomeric material such as silicone. Surrounding the inner surface layer 502 is an outer thicker layer of similar material 504. Interposed between the inner layer 502 and outer layer 504 are a series of parallel spacer bands 506, which, together define a plurality of parallel expandable annular spaces 508a, b, c. When chambers 508a, b, c are pressurized, the inner circumferential surface layer 502, being thinner and more stretchable than outer layer 504, it stretches inward and is forced against the penile shaft P. After chamber 508a is expanded, when pressure in chamber 508 reaches a preset value, a valve (not shown) transfers air into space 508b which expands as shown in FIGS. 25A-H and 26A-H. When chamber 508b is filled, pressure builds up to another preset value and air moves from chamber 508b through a second valve to chamber 508c.

In one embodiment of the present invention, an inflatable cuff 500 having a plurality of inflatable annular chambers 508 is fitted within the tightening compartment 36 of the dual sheath assembly 12, encircling the shaft of the penis P within vacuum compartment 24. The chambers are configured to expand and contract in linear sequence in order to rehabilitate and rejuvenate the penis P of a patient suffering from ED.

In order to induce erection of a user's flaccid penis P who is suffering from ED, tightening compartment 36 may be expanded to translate inwardly, decrease the size of the vacuum compartment 24 and create an airtight seal against the flaccid penis P. As vacuum is created within the vacuum compartment 24, the flaccid penis P is urged deep into vacuum compartment 24 and becomes erect. As the annular chambers 508 are sequentially pressurized, blood is trapped within the corpora cavernosa of the shaft, expanding the sinusoids, stretching the tunica albuginea, and enhancing rigidity of the user's penis P. Regular use of this exercise is expected to increase the length and girth of the patient's penis P. This applies not only to patient's suffering from ED, but potentially for other users who want to maintain and/or augment their sexual potential.

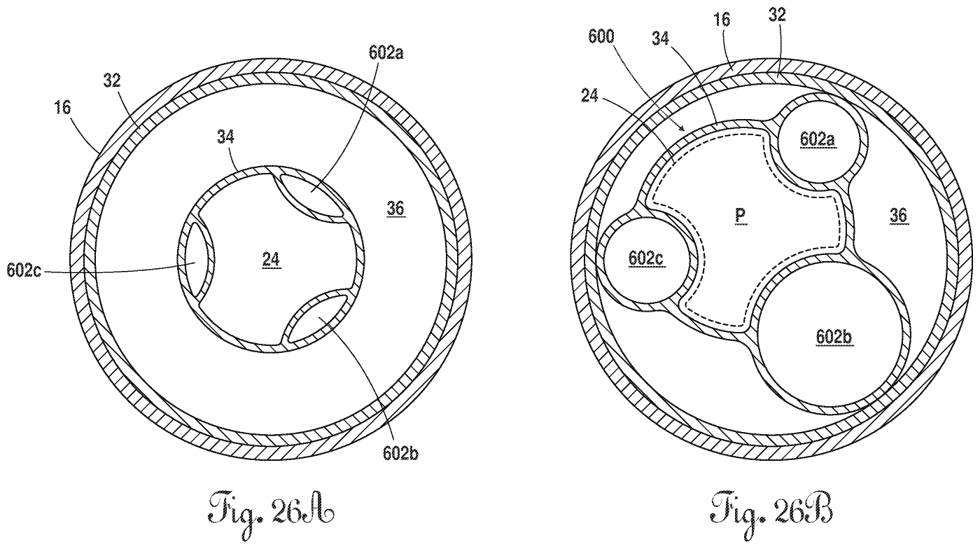

Referring now to FIG. 24A-H, a penis P is shown in phantom within the vacuum compartment 24 of inflatable cuff 500 fitted within tightening compartment 36 of dual sheath assembly 12. The rest of the components of assembly 12 are not shown for the sake of simplification. Inflatable cuff 500 has a plurality of inflatable annular chambers 502, which are configured to expand and contract in linear sequence in order to rehabilitate and rejuvenate the penis P of a patient suffering from ED. Arrow A indicates the proximal to distal axis and the direction of the vacuum device at the nipple 40 of vacuum cylinder 18 shown in FIG. 1.

The most proximal annular chamber AC1 is inflated first and, as it stretches inward toward the longitudinal axis of the vacuum compartment it reduces the diameter of the vacuum compartment 24 and is forced against the dorsum of the penile shaft at its base, thereby constricting the dorsal penile vein and venous return from the shaft of the penis P and trapping blood therein as shown in FIG. 24A. AC1 remains inflated throughout the inflation/deflation wave cycle. In one embodiment shown in FIG. 24A-D, as AC2 is deflated, AC3 is inflated; as AC3 is deflated AC4 is inflated, and so on. In another embodiment, (not shown), AC1, AC2, AC . . . are inflated in a wave form without interim chamber deflation until the end of the cycle. As chambers AC2, AC3 . . . expand sequentially and distally in the direction of the arrow A along the proximal to distal axis, the shaft is further compressed, causing the blood trapped in the corpora cavernosa to be forced distally along the shaft, increasing the turgor and rigidity of the penis P.

Another mode of peristaltic wave is shown in FIGS. 25A-H. As shown, two adjacent annular chambers are inflated at any one time, as in AC1-AC2, AC2-AC3, AC3-AC4. Other variations on the inflation/deflation sequence may be devised as desired and are within the scope of the present invention.

With reference to FIG. 27, a multi-port flexible conduit enclosing fluid lines 180a-d is connected to the cuff 500 and is configured to provide individual ports to each chamber 508. The individually expandable chambers 508 are formed of an elastomeric polymer that act in such a manner that when they are relaxed, they retract to a flat nested position within cuff 500 as shown in FIG. The material of the cuff 500 may be any suitable elastomeric polymer suitable for the present application, such as silicone, nylon, latex, etc.

Since the tightening compartment 36 is constrained by rigid tubular member 16, within vacuum cylinder 18, pressurization of the tightening compartment 36 and/or creating vacuum within compartment 24 biases cuff 500 inwardly or outwardly in a similar fashion as elastic layer 34 shown in FIGS. 22A-B and 23A-B. Each chamber 508 is inflatable to further decrease the diameter of the vacuum chamber 24 and applies selective pressure on the outer surface of the erect penis P within the vacuum compartment 24. The length of the cuff 500 is longer than the length of a particular user's penis, to allow for stretching and lengthening of the penis P over time.

Referring to FIG. 27 (functional flow diagram), the flexible conduit (not shown), connected at one end to cuff 500, may be connected at the other end to a sequential valve 506 to deliver intermittent pneumatic pressure in sequence to cuff 500, allowing one annular chamber 508 to be pressurized at a given time.

The multi-port conduit 510 may be connected to a solenoid valve 190, which allows each expandable chamber 508 to be separately inflated and deflated. Controller 191 is electrically connected to the 3-way valves 190 that energize the valves 190 in sequence at a given time and duration, allowing pressure modulation and amplitude modulation by setting the sequence in shorter or longer time durations as desired.

### III: Cuff Having Inflatable Eccentric Chambers to Treat Peyronie's Disease

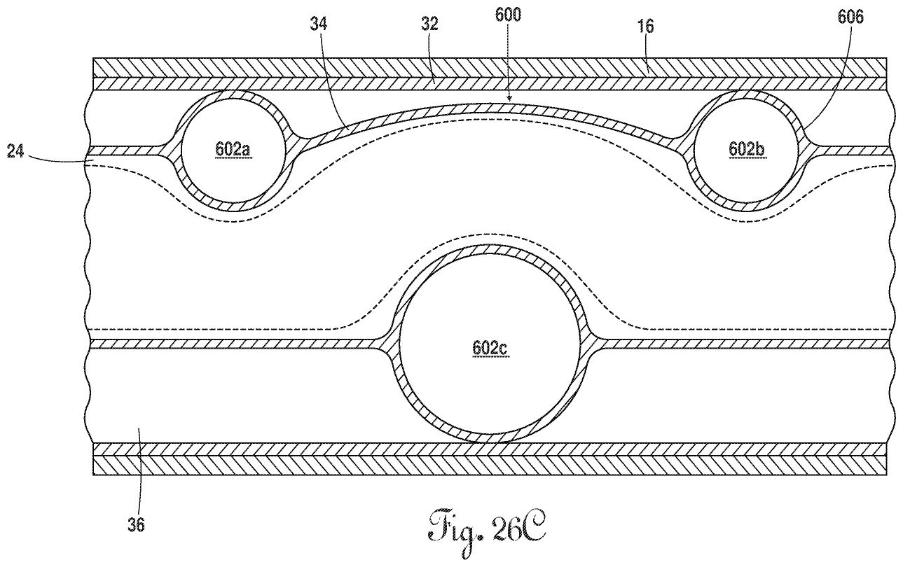

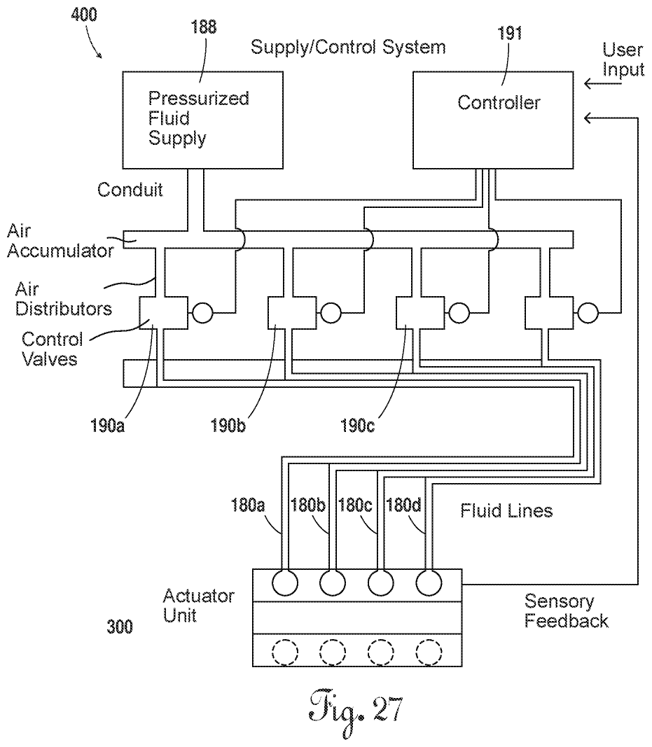

In one embodiment of the present invention, illustrated in FIGS. 26A-C, an inflatable cuff 600 is interposed between tightening compartment 36 and vacuum compartment 24 of dual sheath assembly 12. The cuff 600 is provided with a plurality of expandable chambers 602 arranged in an eccentric fashion within the inner elastic layer 34 of dual sheath assembly 12. The spaces are inflated selectively for applying contralateral penile traction and bending forces to the erect penis P within vacuum compartment 24 to treat PD. Chambers 602 may be positioned at a plurality of different locations in the axial and longitudinal plane within tightening compartment 36.

Inner elastic layer 34 may be formed by fusion of two or more elastomeric layers having spaces in between the layers defining expandable spaces 602a, b, c, etc. The layers may be thin, resilient, and stretchy. Optionally, the outer surface layer may be thicker and therefore less stretchy than the inner surface layer, in order to expand spaces 602 inwardly towards the vacuum compartment 24. In some applications, tightening compartment 36 may be pressurized in order to exert a constraining effect on the erect penis P within vacuum compartment 24. This may also permit adjustment to organs of different diameters. Volume expandable chambers 602 may be formed of different sizes. Bands 606 between chambers 602 may be of variable length and tailored for a specific application.

The plurality of volume expandable chambers 602 are connected to a multi-port flexible conduit 180 configured to provide individual ports to each chamber 602.

### IV: Supply/Control System

FIG. 27 depicts an exemplary supply/control system 400 for at least one actuator unit 300. Each actuator unit 300 comprises at least two actuator segments 202 and 204 formed of a plurality of pressurizable chambers each, such as 100a, b, c, d. Fluid lines 180 feed fluid (air) to the balloons 100a-d of segments 202 and 204 respectively. Interposed between each fluid line 180 and a pressurized fluid supply 188 are four control valves 190a, 190b, 190c, and 190d. Although not shown, multiple valves could be used on each fluid line 180, with one valve serving as fluid inlet and another valve serving as exhaust. Valves 190a-190d can be of any of a variety of electrically controlled valves known in the art and commercially available, and are controlled by separate electrical control lines supplying control signals to valves 190a-190d. These control signals are issued by a controller 191, which may comprise a microprocessor and associated hardware and software, or any other single or combination of devices for processing electrical signals. Controller 191 receives sensory feedback from sensors on one or more of the actuators. Controller 191 also receives user input, which can range from commands as simple as on/off, forward/reverse, to complex pressurization, pulsating motions etc. Controller 191 combines these commands and/or sensory feedback inputs, and issues control signals to valves 190a-190d to inflate or deflate individual balloons 100 as necessary to achieve desired treatment protocol for the management of ED and PD. Microprocessors and other electronic components necessary to construct the controller 191, as well as the proper combination and programming thereof, are well known in the art. However, specifically desired sequence or sequences of pressurization, dwell times, and depressurization may be designed and modified by the treating physician. Accordingly, details of the controllers instruction and programming to control the actuators of the invention are not necessary.

The supply/control system 400 further comprises a pressurized fluid supply unit 188, such as an air compressor, having its outlet connected by a conduit 186 to an air accumulator 184 via a suitable regulator. The air accumulator 184 is optional and merely comprises a large chamber designed to act as a buffer and to avoid pressure fluctuations in the system. Alternatively, of course, the compressor can be replaced by an available source of pressurized air, commonly found in hospitals and other medical facilities. The fluid path is couplable to a pressurized fluid source. A plurality of valves 190 are disposed along the fluid path and a plurality of sensors are disposed in different locations within the dual sheath assembly 12. A controller 191 is coupled to the valves and to the sensors. The controller 191 is configured to measure a characteristic of the valve by actuating the valve and monitoring a plurality of pressure sensors, and strain sensors for measuring the location and intensity of the applied pressure. The controller 191 is also configured to relay a treatment protocol in response to the measured valve characteristic, and to assist the physician in implementing the treatment protocol by actuating the valve so as to modify the tissue pressurization as needed.

Optionally, the pump may include a low-pressure chamber. In a preferred mode of operation, when the low-pressure chamber contracts due to the pressure differential between that of the pressure at the level of the pump and the pressure exerted particularly on a pressurizable eccentric balloon by the user's erect penis at a particular location, fluid will flow at a predetermined rate from the pump into the pressurizable balloon so as to slowly and gradually expand the latter to the extent necessary for it to impact with sufficient force to bend or stretch a particular portion of the organ. The rate of this flow can also be determined by the geometry and elastic modulus of the pressurization balloon, which will be counteracted by the resistance of the penile tissue contacting the pressurization balloon(s).

The outlet from the accumulator 184 is in turn to be connected by air distributors 182 that individually supply control valves 190a-190d and therefrom to fluid lines 180a-d. Each fluid line 180 is fluidly connected to each of the balloon chambers 100. The air distributor 182 may be contained within a housing, and a circular air distributor plate and/or sequential valve (not shown) may be configured to deliver intermittent pneumatic pressure to the actuator unit 300 and allowing at least one chamber 100 to be pressurized at a given time.

In another embodiment, depicted in FIG. 27, the plurality of control valves 190 may be in the form of 3-way solenoid valves that are manifolded together and connected to the fluid lines 180a-d which allows each expandable chamber 508 FIG. 22A, for example, to be separately inflated and deflated.

In another embodiment, best depicted in FIG. 27, a plurality of 3-way solenoid valves are manifolded together and attached to the conduit which allows each expandable chamber to be separately inflated and deflated. To facilitate deflation of the balloons, the first volume of the balloon chamber includes at least one exhaust port. Additionally, a check valve may be disposed between the chamber and one balloon with the check valve permitting flow of fluid in one direction. An inflation valve may be disposed between the chamber and the pressure source, with the inflation valve actuated by a bottom or trigger mechanism. A regulator can be disposed between the pressure source and the pressurizable chamber. The pressure setting of the regulator can be maintained at a constant value, or variably controlled by a switch, valve, or trigger.

The fluid circuit and the control unit can be scaled to fit within a housing or handle, if so desired. The handle can be configured to provide a physician or user with the ease of automatic, sequential inflation and deflation of the expandable chambers within the tightening compartment 36 by, in some embodiments, a one-touch actuator. In this manner, the actuator can be a switch, button, knob, or other mechanism adapted to permit a user to inflate the expandable members when actuated in a first position or direction, and to deflate the members when actuated in a second direction. In some embodiments, the switch is configured such that the user cannot overinflate the expandable member.

The valve will often comprise a solenoid valve and the valve performance characteristic may be measured by determining a command pulse width for actuating the valve. The command pulse width can be measured using a controller of the probe system, with the controller of the probe system also implementing the treatment protocol by: a). Transmitting a command pulse having the command pulse width to the valve; b). Measuring a fluid pressure adjacent to or downstream of the fluid path in response to the preceding command pulse; c). Comparing the measured pressure to a target pressure; d). Repeating a)c) in response to the measured pressure being less than the target pressure; and e). Ending a)d) in response to the measured pressure being greater than the target pressure. The target pressure can be changed as a function of time, for example, the target may increase linearly as a function of increasing time, thereby providing a smooth and gradual increase in inflation pressure. In some embodiments, the pressure may increase at a first rate during a first portion of the inflation cycle, and may then increase at a second rate during a second portion of the inflation cycle. For example, a relatively low initial inflation rate of less than 10 psi/see may be used to gradually inflate a balloon from a deflated profile configuration to a partial inflated configuration whereby the inner elastic layer 34 is in conforming profile against the user's penis, and may then be followed by an inflation rate of over 10 psi/sec. To achieve a treatment target or to elicit a response from the patient as to adequacy of the pressure or sensation of discomfort. Such smooth and gradual inflation may avoid rapid or excessive bending of the user's erect penis, and the like. Tissue pressurization can be accurately controlled throughout the treatment cycle, and patient feedback and participation is encouraged.

The controller 191 may be configured to change the target pressure and the pressure distribution along the array of balloons as a function of time. Each balloon is ported separately to a central location C near the proximal end 26 of the dual sheath assembly 12 where fluid lines 180a-d extend through a multipart flexible conduit. The other end of conduit is connected to a sequential valve, control valves 190, to distribute fluid pressure in sequence to the balloons, allowing one or more selected balloons to be pressurized at a given time. This operates with a common pressure chamber in the valve body on the entering fluid side.

In one embodiment, shown in FIG. 27, a fluid conduit is connected to a sequential valve to divert intermittent pneumatic pressure in sequence to the plurality of pressurizable chambers 508, allowing a selected chamber or chambers to be pressurized at a given time. This operates with a common pressure chamber in the valve body on the entering air side and a plurality of sequestered chambers on the leaving air side with rotatable circular valve plate therebetween. Rotation of plate creates a series of pressurization and depressurization steps through an exhaust port. This movement of the sequenced pneumatic source creates a wave effect of the expanding and contracting pressurization chambers or balloons, for example 508a, b, c, or 602a, b, c creating a pumping or pulsating action upon the penis in linear fashion from proximal to distal or vice versa.

In another embodiment, best described in FIG. 27, a plurality of solenoid valves are manifolded together and attached to conduit, which allows each expandable chamber to be separately inflated and deflated.

I claim:

1. An external penile device for use in the treatment of erectile dysfunction and Peyronie's disease, the device comprising;
a dual sheath assembly having an outer elastomeric tube and an inner elastomeric tube, the tubes forming a volume expandable outer annular space defining a tightening compartment, containing a plurality of pressurizable chambers, and a concentric inner tubular space defining a vacuum compartment receptive to a user's penis;
said outer elastomeric tube being substantially fixed and constrained by a rigid vacuum cylinder and said inner elastomeric tube being axially mobile and having an inner diameter which is varied by changing the volumes of the expandable outer annular space and the inner tubular space;
a supply/control system for inflating and defeating said plurality of pressurizable chambers in a sequential manner, whereby said penile shaft is compressed or bent according to a treatment protocol.

2. The device in accordance with claim 1, wherein said tightening compartment is formed by joining the ends of at least two tubular elastic layers.

3. The device in accordance with claim 1, wherein said two tubular elastic layers of said dual sheath assembly are arranged concentrically to form a tube within a tube.

4. The device in accordance with claim 1, wherein said vacuum compartment is created within said inner elastic layer of said dual sheath assembly.

5. The device in accordance with claim 1, wherein said dual sheath assembly includes a vacuum compartment having a distal end for operable connection to a vacuum generating device, and an open proximal end receptive of a user's penis.

6. The device in accordance with claim 1, wherein a tightening compartment is created between the inner and outer tubular elastic layers of said dual sheath assembly.

7. The device in accordance with claim 6, wherein said vacuum compartment and said tightening compartment are circumferentially spaced from each other.

8. The device in accordance with claim 6, wherein said tightening compartment is segmented into a plurality of pressurizable chambers in the form of eccentric balloons

9. The device in accordance with claim 6, wherein said tightening compartment is segmented into a plurality of annular chambers.

10. The device in accordance with claim 6, wherein the cuff is provided with a plurality of expandable chambers interposed between the tightening compartment and the vacuum compartment.

11. The device in accordance with claim 6, wherein said pressurizable chambers are integrated with said inner elastomeric tube.

12. The device in accordance with claim 6, wherein said pressurizable chambers are arranged eccentrically within said inner elastomeric tube

13. The device in accordance with claim 6, wherein said chambered compartments being pneumatically isolated from each other so that pressurization and depressurization of said chambered compartments may be controlled independently.

14. The device in accordance to claim 1, wherein said outer annular space includes a multi-chamber balloon assembly mounted at the distal end of an elongate fluid-supply tube.

15. The device according with claim 11 wherein the elongate fluid supply tube having proximal and distal ends, and a plurality of lumens therethrough.

16. The multi chamber balloon assembly of claim 11 having at least one set of serially arrayed eccentric balloons mounted at the distal end of said elongate fluid supply tube, each balloon communicating with a separate lumen.

17. The supply/control system of claim 1, being mounted at the proximal end of said fluid supply tube.

18. The multi chamber balloon assembly of claim 11 comprising an inflatable cuff positioned within the tightening compartment and connected to the inner elastic layer, said inflatable cuff having a plurality of annular expandable chambers.

19. The multi chamber balloon assembly of claim 11 comprising an inflatable cuff positioned within the tightening compartment and connected to the inner elastic layer, said inflatable cuff having a plurality of eccentric expandable balloons

20. The supply/control system of claim 1, for inflating at least two expandable annular chambers in a sequential manner along a proximal to distal axis of the user's penile shaft, whereby said shaft is first constricted proximally, and then progressively constricted distally to thereby stretch the corpora cavernosa and the tunica albuginea of the user's penile shaft, stretch the penile shaft, and increase its girth, and enhance its rigidity.

21. The device according to claim 17 for inflating at least two expandable eccentric chambers within the tightening compartment for applying contralateral compression forces on the user's erect penis within the vacuum compartment to aid in the treatment of a patient suffering from symptomatic PD.

22. The device according to claim 17 for inflating at least two expandable eccentric chambers within the tightening compartment for applying contralateral bending forces on the user's erect penis within the vacuum compartment to aid in the treatment of a patient suffering from symptomatic PD.

23. The device according to claim 17 for inflating at least two expandable eccentric chambers within the tightening compartment for applying traction forces on the user's erect penis within the vacuum compartment to aid in the treatment of a patient suffering from symptomatic PD.
